(19) United States
(12) Patent Application Publication
(10) Pub. No.: US 2025/0039980 A1
(43) Pub. Date: Jan. 30, 2025

(54) COMMUNICATION METHOD AND APPARATUS, DEVICE, STORAGE MEDIUM, CHIP, PRODUCT, AND PROGRAM

(71) Applicant: GUANGDONG OPPO MOBILE TELECOMMUNICATIONS CORP., LTD., Dongguan (CN)

(72) Inventors: Yi HU, Dongguan (CN); Haitao LI, Dongguan (CN)

(21) Appl. No.: 18/912,850

(22) Filed: Oct. 11, 2024

Related U.S. Application Data
(63) Continuation of application No. PCT/CN2022/104112, filed on Jul. 6, 2022.

(51) Int. Cl. H04W 76/28; H04W 24/08; H04W 68/02; H04W 76/30

(52) U.S. Cl. CPC H04W 76/28; H04W 24/08; H04W 68/02; H04W 76/30

(57) ABSTRACT

Embodiments of the present application provide a communication method and apparatus, a device, a storage medium, a chip, a product, and a program. The method comprises: a terminal device receives first information sent by a first network device; the terminal device determines, on the basis of the first information, whether to use a first extended discontinuous reception (eDRX) parameter to monitor paging, wherein the first eDRX parameter comprises a first eDRX period and/or a paging time window (PTW), and the first eDRX period is greater than a predetermined period.

### CROSS-REFERENCE TO RELATED APPLICATION

This is a continuation n of International Patent Application No. PCT/CN2022/104112, filed on Jul. 6, 2022, the disclosure of which is hereby incorporated by reference in its entirety.

### BACKGROUND

An Extended Discontinuous Reception (eDRX) mechanism is introduced in R17. The eDRX mechanism achieves further power saving in a terminal device by supporting a longer paging cycle.

In the related art, there may be differences in support status for the eDRX function among various network devices. For example, some network devices support longer eDRX cycles, while some network devices support shorter eDRX cycles.

### SUMMARY

Embodiments of the disclosure relate to the technical field of communications, and more particularly to communication methods.

In a first aspect, an embodiment of the disclosure provides a communication method, which includes the following operations. A terminal device receives first information from a first network device. The terminal device determines whether to monitor a paging using a first eDRX parameter based on the first information. The first eDRX parameter includes a first eDRX cycle and/or a Paging Time Window (PTW), and the first eDRX cycle is greater than a predefined cycle.

In a second aspect, an embodiment of the disclosure provides a communication method, which includes the following operations. A first network device sends first information to a terminal device. The first network device determines whether to send a paging using a first eDRX parameter based on the first information. The first eDRX parameter includes a first eDRX cycle and/or a PTW, and the first eDRX cycle is greater than a predefined cycle.

In a third aspect, an embodiment of the disclosure provides a communication method, which includes the following operations. A second network device sends a paging carrying a first eDRX parameter to a first network device. The first eDRX parameter includes a first eDRX cycle and/or a PTW, and the first eDRX cycle is greater than a predefined cycle.

### BRIEF DESCRIPTION OF THE DRAWINGS

The drawings described herein are used for providing a further understanding of the disclosure and constitute a part of the disclosure. Exemplary embodiments of the disclosure and description thereof are used for illustrating the disclosure and not intended to form an improper limit to the disclosure. In the drawings:

FIG. 1 is a schematic diagram illustrating an application scenario according to an embodiment of the disclosure.

FIG. 2 is a flowchart illustrating a communication method according to an embodiment of the disclosure.

FIG. 3 is a flowchart illustrating another communication method according to an embodiment of the disclosure.

FIG. 4 is a flowchart illustrating yet another communication method according to an embodiment of the disclosure.

FIG. 5 is a flowchart illustrating a method for a terminal device to monitor a paging according to an embodiment of the disclosure.

FIG. 6 is a flowchart illustrating another method for a terminal device to monitor a paging according to an embodiment of the disclosure.

FIG. 7 is a flowchart illustrating yet another method for a terminal device to monitor a paging according to an embodiment of the disclosure.

FIG. 8 is a flowchart illustrating still another method for a terminal device to monitor a paging according to an embodiment of the disclosure.

FIG. 9 is a flowchart illustrating a method for a terminal device to monitor a paging according to another embodiment of the disclosure.

FIG. 10 is a flowchart illustrating a method for a terminal device to monitor a paging according to yet another embodiment of the disclosure.

FIG. 11 is a schematic diagram illustrating a structural composition of a communication apparatus according to an embodiment of the disclosure.

FIG. 12 is a schematic diagram illustrating a structural composition of another communication apparatus according to an embodiment of the disclosure.

FIG. 13 is a schematic diagram illustrating a structural composition of yet another communication apparatus according to an embodiment of the disclosure.

FIG. 14 is a schematic structural diagram of an electronic device according to an embodiment of the disclosure.

FIG. 15 is a schematic structural diagram of a chip according to an embodiment of the disclosure.

### DETAILED DESCRIPTION

Technical solutions in the embodiments of the disclosure will be described below in combination with the drawings in the embodiments of the disclosure. It is apparent that the described embodiments are not all embodiments but part of embodiments of the disclosure. All other embodiments obtained by those of ordinary skill in the art based on the embodiments in the disclosure without creative work shall fall within the scope of protection of the disclosure.

The technical solutions described in the embodiments of the disclosure may be arbitrarily combined without conflicting with each other. In the description of the disclosure, “multiple/a plurality of” refers to two or more, unless otherwise specifically defined.

FIG. 1 is a schematic diagram illustrating an application scenario according to an embodiment of the disclosure. As illustrated in FIG. 1, the communication system 100 may include a terminal device 110, a network device 120 and a core network device 130. The network device 120 may communicate with the terminal device 110 through an air interface. Multi-service transmission is supported between the terminal device 110 and the network device 120.

It should be understood that the embodiments of the disclosure are described only using the communication system 100 as an example, but are not limited thereto. That is, the technical solutions of the embodiments of the disclosure may be applied to various communication systems, for example, a Long Term Evolution (LTE) system, an LTE Time Division Duplex (TDD) system, a Universal Mobile Telecommunication System (UMTS), an Internet of Things (IoT) system, a Narrow Band Internet of Things (NB-IoT) system, an enhanced Machine-Type Communication (eMTC) system, a 5th Generation (5G) communication system (also called a New Radio (NR) communication system), a future communication system (e.g., a 6th Generation (6G) communication system, a 7th Generation (7G) communication system), and/or the like.

The network device 120 in the embodiment of the disclosure may include an access network device. The access network device may provide communication coverage for a specific geographical region and may communicate with the terminal device 110 (e.g., UE) located in the coverage.

The terminal device in the disclosure may be referred to as User Equipment (UE), a Mobile Station (MS), a Mobile Terminal (MT), a user unit, a user station, a mobile station, a remote station, a remote terminal, a mobile device, a user terminal, a terminal, a wireless communication device, a user agent or a user apparatus. The terminal device may include one or a combination of at least two of the followings: an IoT device, a satellite terminal, a Wireless Local Loop (WLL) station, a Personal Digital Assistant (PDA), a handheld device with a wireless communication function, a computing device or other processing devices connected to a wireless modem, a server, a mobile phone, a pad, a computer with a wireless transceiver function, a palmtop computer, a desktop computer, a personal digital assistant, a portable media player, a smart speaker, a navigation device, a wearable device such as a smart watch, smart glasses, a smart necklace or the like, a pedometer, a digital television (TV), a Virtual Reality (VR) terminal device, an Augmented Reality (AR) terminal device, a wireless terminal in an industrial control, a wireless terminal in self driving, a wireless terminal in a remote medical surgery, a wireless terminal in a smart grid, a wireless terminal in a transportation safety, a wireless terminal in a smart city, a wireless terminal in a smart home, or a vehicle, a vehicle-mounted device, a vehicle-mounted module, a wireless modem, a handheld device, Customer Premise Equipment (CPE) and a smart appliance in an Internet of vehicles system.

Optionally, the terminal device 110 may be any terminal device, which includes but is not limited to a terminal device that is wired or wirelessly connected to the network device 120 or other terminal devices.

Optionally, the terminal device 110 may be used for a Device to Device (D2D) communication.

The access network device may include one or a combination of at least two of the followings: an Evolutional Node B (eNB or eNodeB) in an LTE system, a Next Generation Radio Access Network (NG RAN) device, a base station (gNB) in an NR system, a small station, a micro station, a wireless controller in a Cloud Radio Access Network (CRAN), a Wireless-Fidelity (Wi-Fi) access point, a transmission reception point (TRP), a relay station, an access point, a vehicle-mounted device, a wearable device, a hub, a switch, a network bridge, a router, a network device in a future evolutional Public Land Mobile Network (PLMN), and/or the like.

The core network device 130 may be a 5G Core (5GC) device, and the core network device 130 may include one or a combination of at least two of the followings: an Access and Mobility Management Function (AMF), an Authentication Server Function (AUSF), a User Plane Function (UPF), a Session Management Function (SMF), a Location Management Function (LMF), a Policy Control Function (PCF). In some other implementations, the core network device may also be an Evolved Packet Core (EPC) device in an LTE network, for example, a Session Management Function+Core Packet Gateway (SMF+PGW-C) device. It should be understood that the SMF+PGW-C can implement both the functions that can be implemented by the SMF and the PGW-C. In the process of network evolution, the core network device 130 may also be called by other names, or at least one new network entity may be formed by dividing the functions of the core network, which is not limited by the embodiment of the disclosure.

Connections may be established between various functional units of the communication system 100 through a next generation (NG) interface to realize communication. For example, the terminal device establishes an air interface connection with the access network device through an NR interface, for transmitting user plane data and control plane signaling. The terminal device may establish a control plane signaling connection with the AMF through an NG interface 1 (abbreviated as N1). The access network device, such as a next generation radio access base station (gNB), may establish a user plane data connection with the UPF through an NG interface 3 (abbreviated as N3). The access network device may establish a control plane signaling connection with the AMF through an NG interface 2 (abbreviated as N2). The UPF may establish a control plane signaling connection with the SMF through an NG interface 4 (abbreviated as N4). The UPF may interact user plane data with a data network through an NG interface 6 (abbreviated as N6). The AMF may establish a control plane signaling connection with the SMF through an NG interface 11 (abbreviated as N11). The SMF may establish a control plane signaling connection with the PCF through an NG Interface 7 (abbreviated as N7).

FIG. 1 exemplarily illustrates one base station, one core network device, and two terminal devices. Optionally, the wireless communication system 100 may include multiple base stations and other number of terminal devices in the coverage of each base station, which is not limited by the embodiments of the disclosure.

It should be noted that FIG. 1 illustrates the system to which the disclosure is applicable by way of example only. The methods illustrated in the embodiments of the disclosure may also be applicable to other systems. In addition, the terms “system” and “network” are usually used interchangeably herein. Herein, the term “and/or” is merely an association relationship that describes associated objects, and represents that three relationships may exist. For example, A and/or B may represent three situations: independent existence of A, existence of both A and B, and independent existence of B. In addition, the character “/” used herein usually represents that the associated objects before and after the character “/” form an “or” relationship. It should also be understood that “indication/indicate/indicating” mentioned in the embodiments of the disclosure may be a direct indication, an indirect indication, or representation of an association relationship. For example, A indicates B, which may represent that A directly indicates B, e.g., B may be obtained from A; or may represent that A indirectly indicates B, e.g., A indicates C and B may be obtained from C; or may represent that there is an association relationship between A and B. It should also be understood that the “correspondence/correspond/corresponding” mentioned in the embodiments of the disclosure may represent that there is a direct correspondence or an indirect correspondence between two objects; or may represent an association relationship between the two objects, or a relationship between indication and being indicated, between configuration and being configured or the like. It should also be understood that the “predefinition/predefine”, “predefined by a protocol”, “pre-determination/pre-determine” or “predefined rule” mentioned in the embodiments of the disclosure may be implemented by pre-storing corresponding codes or tables in devices (e.g., including terminal devices and network devices) or by other ways that may be used to indicate related information, and the specific implementation thereof is not limited herein. For example, the predefinition may refer to what is defined in the protocol. It should also be understood that in the embodiments of the disclosure, the “protocol” may refer to standard protocols in the communication field, including such as an LTE protocol, a NR protocol, and related protocols to be applied in a future communication system, which are not limited herein.

In order to facilitate understanding of the technical solutions in the embodiments of the disclosure, the related art of the embodiments of the disclosure will be described below. The following related art may be used as an optional solution and arbitrarily combined with the technical solutions in the embodiments of the disclosure, and all of them belongs to the scope of protection of the embodiments of the disclosure.

At present, with the pursuit of speed, latency, high-speed mobility and energy efficiency, and the diversity and complexity of service in a future life, the 3rd Generation Partnership Project (3GPP) international standards organization began to develop a 5th Generation Mobile Communication Technology (5G). The main application scenarios of the 5G include Enhanced Mobile Broadband (cMBB), Ultra-reliable and Low Latency Communications (URLLC) and Massive Machine Type Communication (mMTC).

The eMBB still aims to provide users with multimedia content, services and data, and a demand for the eMBB grows rapidly. On the other hand, since the eMBB may be deployed in different scenarios, such as indoors, urban areas, rural areas, etc., its capabilities and requirements vary greatly, so it cannot be generalized and must be analyzed in detail based on specific deployment scenarios. Typical applications of the URLLC include: industrial automation, power automation, remote medical operations (surgery), traffic safety assurance, etc. Typical characteristics of the mMTC include: high connection density, small data volume, latency-insensitive services, low cost and long service life of modules, etc.

New Radio (NR) can also be deployed independently. In a 5G network environment, a new Radio Resource Control (RRC) state i.e., an RRC inactive or deactivated (i.e., RRC_INACTIVE) state is defined in order to reduce air interface signaling, quickly recover wireless connections and quickly recover data services. The RRC inactive state is different from an RRC idle (i.e., RRC_IDLE) state and an RRC active (i.e., RRC_ACTIVE) state. The RRC active state may be understood as the same as the RRC connected (i.e., RRC_CONNECTED) state. In any embodiment of the disclosure, RRC_INACTIVE and INACTIVE are understood to be the same, and RRC_IDLE and IDLE are understood to be the same.

In the RRC_IDLE state, mobility is based on cell selection and reselection of the UE, a paging is initiated by a Core Network (CN) and a paging area is configured by the CN. There is no Access Stratum (AS) context of the UE at a base station side, and there is no RRC connection.

In the RRC_CONNECTED state, the RRC connection exists, and the AS context of the UE exist at the base station and the UE. A network side knows a location of the UE at a cell-specific level. Mobility is controlled by the network side. Unicast data may be transmitted between the UE and the base station.

In the RRC_INACTIVE state, mobility is based on cell selection and reselection of the UE, there is a connection between the CN and the NR, the AS context of the UE exists on a certain base station, the paging is triggered by a Radio Access Network (RAN), an RAN-based paging area is managed by the RAN, and the network side knows the location of the UE at an RAN-based paging area level.

A paging mechanism in the NR is described below.

The main function of the paging is to enable a network to page the UE through a paging message when the UE is in the RRC_IDLE state or the RRC_INACTIVE state, or notify the UE of a system message change or an earthquake/tsunami/public warning information through a short message (which is applicable to all RRC states of the UE, including the connected state).

The paging may include Physical Downlink Control Channel (PDCCH) scrambled by Paging-Radio Network Temporary Identity (P-RNTI) and Physical Downlink Share Channel (PDSCH) scheduled by the PDCCH. The paging message is transmitted in the PDSCH, and the short message has a length of 8 bits and in the PDCCH.

For the UE in the RRC_IDLE state or the RRC_INACTIVE state, since there is no other data communication between the UE and the network, the UE may discontinuously monitor a paging channel, that is, by adopting a paging Discontinuous Reception (DRX) mechanism, to save power for the UE. In the paging DRX mechanism, the UE only monitors the paging during a paging occasion (PO) in each DRX cycle. The PO is composed of a series of PDCCH monitoring occasions, while may be composed of multiple slots. In addition, a Paging frame (PF) is also introduced. The PF refers to a radio frame (fixed 10 ms), and the radio frame may contain multiple POs or starting locations of the multiple POs.

A paging DRX cycle is jointly determined by a common cycle in a system broadcast and a specific cycle configured in high-layer signaling (non-access stratum (NAS) signaling), and the UE determines a minimum cycle from the common cycle and the specific cycle as the paging cycle. From a perspective of the network, the paging DRX cycle may include multiple POs, and a location in which the UE monitors the PO is related to an Identity (ID) of the UE (i.e., UE_ID). Specifically, the PO and the PF in the paging DRX is determined for a certain UE as follows.

A System Frame Number (SFN) of the PF is determined by the following formula: (SFN+PF_offset) mod T=(T div N)*(UE_ID mod N).

An index (i_s) of the PO in the PF is determined by the following formula: i_s=floor (UE_ID/N) mod Ns.

T denotes a DRX cycle for receiving the paging by the UE. The network broadcasts a default DRX cycle, and if the RRC/high-layer configures a UE-specific DRX cycle for the UE, the minimum cycle in the DRX cycle broadcast by the network and the UE-specific DRX cycle configured by the RRC/high-layer is taken as the DRX cycle of the UE. If the RRC/high-layer does not configure a UE-specific DRX cycle for the UE, the DRX cycle broadcast by the network is taken as the DRX cycle of the UE. N denotes the number of PFs in one DRX cycle, Ns denotes the number of POs in one PF, PF_offset denotes a time domain offset for determining the PF, and UE_ID denotes 5G-System Architecture Evolved-Temporary Mobile Subscriber Identity (SAE-TMSI) mod 1024. The SAE-TMSI may be abbreviated as S-TMSI.

The location of PF and the index of PO in one paging DRX cycle may be determined for the UE based on the above formulas. The PO is composed of multiple PDCCH monitoring occasions, and one PO contains X PDCCH monitoring occasions, X being equal to the number of Synchronization Signal Blocks (SSBs) actually sent that are broadcast in a Master Information Block (MIB).

After the UE learns the indexes of the PF and the PO, and the number of PDCCH monitoring occasions in the PO, a starting location of a first PDCCH monitoring occasion in the PO may be learned through relevant configuration parameters. The starting location may be configured through the high-layer signaling or is obtained based on the PO index. The UE blindly detects the paging message based on the determined PO.

An NR eDRX mechanism is described below.

In three major application scenarios that support a terminal with a reduced capability (RedCap), an industrial wireless sensor needs to support several years of battery life, while a wearable device needs to support up to one to two weeks of battery life. Considering the power saving requirement of the RedCap terminal, an eDRX mechanism for the RRC_IDLE state and the RRC_INACTIVE state is introduced in the RedCap Work Item (WI) of the R17 to achieve further power saving for the terminal by supporting a longer paging cycle.

For the UE in the RRC_IDLE state, an eDRX parameter is configured by the CN, and a value of a CN eDRX cycle ranges from 2.56 s to 10485.76 s. For the UE in the RRC_INACTIVE state, the eDRX parameter is configured by the RAN, and a value of an RAN eDRX cycle ranges from 2.56 s to 10.24 s. Since the UE in the RRC_INACTIVE state needs to monitor both an RAN paging and a CN paging, the behavior of the UE monitoring the paging needs to consider both a CN eDRX configuration and an RAN eDRX configuration.

From the perspective of the network, for the sake of the flexibility, when implementing the eDRX function, the network may support both the eDRX in the RRC_DLE state and the eDRX in the RRC_INACTIVE state, or may support only one of them. To this end, two pieces of eDRX-related indication information (i.e., eDRX-Allowed-Idle and eDRX-Allowed-Inactive) are introduced into a system message. At present, there are two different interpretations of the meanings represented by these two parameters: one interpretation is that the two parameters are used to indicate whether an eDRX configured by the CN and an eDRX configured by the RAN are allowed to be used in the cell, respectively; and the other interpretation is that the two parameters are used to indicate whether the cell allows the UE in the RRC_IDLE state and the UE in the RRC_INACTIVE state to use the eDRX, respectively. For a UE configured with the eDRX, the UE can use the eDRX when the cell indicates that the eDRX is supported.

If an eDRX cycle configured for the UE does not exceed 10.24 s, the UE takes the eDRX cycle as a paging monitoring cycle. If the eDRX cycle configured for the UE exceeds 10.24 s, the UE monitors the paging in a PTW of each eDRX cycle, and the behavior of the UE monitoring the paging in the PTW may follow the DRX mechanism. Since the CN eDRX cycle may exceed 10.24 s, while the RAN eDRX cycle does not support a configuration exceeding 10.24 s, only a CN PTW exists. However, considering the power saving of the terminal device, it is necessary to enhance the eDRX in the RRC_INACTIVE state, so as to support the RAN eDRX cycle exceeding 10.24 s.

In the related art, there may be differences in support status for the eDRX function among various network devices. For example, some network devices support longer eDRX cycles, while some network devices support shorter eDRX cycles. The issue of how the terminal device monitors a paging when different network devices support different eDRX cycles has not been considered in the art. If the RAN eDRX cycle exceeding 10.24 s is to be supported for the RRC_INACTIVE state, an RAN PTW may be introduced based on a current eDRX design principle. From a perspective of implementation in the base station, there may be differences in the support of an RRC_INACTIVE eDRX function among different base stations. For example, a base station in R17 cannot support the RAN eDRX cycle exceeding 10.24 s, while a base station in R18 may or may not support the RAN eDRX cycle exceeding 10.24 s. For the UE in the RRC_INACTIVE state, if an anchor base station (corresponding to a second network device in the other embodiments) supports the RAN eDRX cycle exceeding 10.24 s, the anchor base station may configure the RAN eDRX cycle exceeding 10.24 s for the UE when releasing the UE, and when the UE moves to another cell, a current serving cell of the UE (corresponding to a first network device in the other embodiments) may not support the RAN eDRX cycle exceeding 10.24 s. In this case, the issue of how the terminal monitors the paging needs to be solved.

In order to facilitate understanding of the technical solutions in the embodiments of the disclosure, the technical solutions in the disclosure will be described in detail below with reference to specific embodiments. The above related art may be arbitrarily combined with the technical solutions in the embodiments of the disclosure as an optional solution, and all of them belong to the scope of protection of the embodiments of the disclosure. The embodiments of the disclosure include at least part of the following contents.

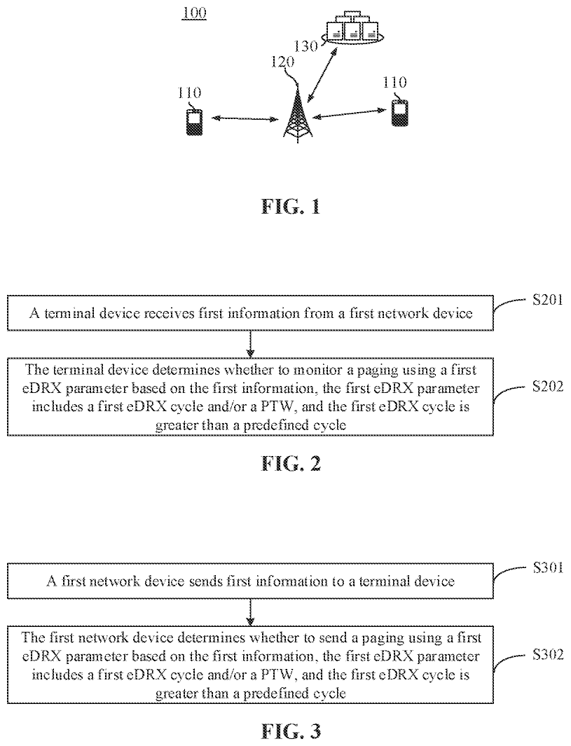

FIG. 2 is a flowchart illustrating a communication method according to an embodiment of the disclosure. As illustrated in FIG. 2, the method includes the following operations.

At operation S201, a terminal device receives first information from a first network device.

At operation S202, the terminal device determines whether to monitor a paging using a first eDRX parameter based on the first information. The first eDRX parameter includes a first eDRX cycle and/or a PTW, and the first eDRX cycle is greater than a predefined cycle.

Optionally, the first network device may be a network device that currently serves the terminal device or where the terminal device currently resides.

Optionally, the first information may indicate a support status of the eDRX function by the network device.

Optionally, the first information may indicate whether an eDRX supported by the first network device is greater than the predefined cycle, or the first information may indicate whether the first network device supports an eDRX cycle greater than the predefined cycle. For example, the first information may indicate that the eDRX supported by the first network device is greater than the predefined cycle. For another example, the first information may indicate that the eDRX supported by the first network device is not greater than the predefined cycle. For example, the first information may indicate that the first network device supports the eDRX cycle greater than the predefined cycle. For another example, the first information may indicate that the first network device does not support the eDRX cycle greater than the predefined cycle.

Optionally, the first network device may support the eDRX or may not support the eDRX. When the first network device supports the eDRX, the first information may further indicate whether the eDRX supported by the first network device is greater than the predefined cycle, or the first information may further indicate whether the first network device supports the eDRX cycle greater than the predefined cycle.

In any embodiment of the disclosure, the eDRX may include an RAN eDRX and/or a CN eDRX unless otherwise specified. In an embodiment of the disclosure, the first information may indicate whether the RAN eDRX and/or the CN eDRX supported by the first network device is greater than the predefined cycle, or the first information may indicate whether the first network device supports an RAN eDRX cycle and/or a CN eDRX cycle greater than the predefined cycle.

Optionally, the first information may indicate a behavior of the terminal device.

Optionally, the first information may indicate whether the terminal device is allowed to use the eDRX cycle greater than the predefined cycle, or the first information may indicate whether a terminal device configured with the eDRX greater than the predefined cycle is allowed to use the eDRX. For example, the first information may indicate that the terminal device is allowed to use the eDRX cycle greater than the predefined cycle. For another example, the first information may indicate that the terminal device is not allowed to use the eDRX cycle greater than the predefined cycle. For example, the first information may indicate that the terminal device configured with the eDRX greater than the predefined cycle is allowed to use the eDRX. For another example, the first information may indicate that the terminal device configured with the eDRX greater than the predefined cycle is not allowed to use the eDRX.

Optionally, when the first information indicates that the eDRX supported by the first network device is greater than the predefined cycle, or when the first information indicates that the first network device supports the eDRX cycle greater than the predefined cycle, or when the first information indicates that the terminal device is allowed to use the eDRX cycle greater than the predefined cycle, or when the first information indicates that the terminal device configured with the eDRX greater than the predefined cycle is allowed to use the eDRX, the terminal device may determine to monitor the paging using the first eDRX parameter.

Optionally, when the first information indicates that the eDRX supported by the first network device is not greater than the predefined cycle, or when the first information indicates that the first network device does not support the eDRX cycle greater than the predefined cycle, or when the first information indicates that the terminal device is not allowed to use the eDRX cycle greater than the predefined cycle, or when the first information indicates that the terminal device configured with the eDRX greater than the predefined cycle is not allowed to use the eDRX, the terminal device may determine not to monitor the paging using the first eDRX parameter.

The first eDRX parameter may include a first RAN eDRX parameter. Optionally, regardless of whether the terminal device monitors the paging using the first RAN eDRX parameter, the terminal device may monitor the paging using the CN eDRX and/or a Discontinuous Reception (DRX). For example, the terminal device may determine whether to monitor the paging using the CN eDRX based on a support status of the CN eDRX sent by the first network device, and/or, when it is determined to monitor the paging using the CN eDRX, determine what kind of the CN eDRX is to be used to monitor the paging. Optionally, the CN eDRX for monitoring the paging may be determined based on a pre-configuration, or may be predefined by a protocol, or may be configured by the first network device, or may be configured by a second network device, or may be configured by a core network.

Optionally, the PTW may be a time window in the first eDRX cycle. Optionally, the PTW may be a duration in the first eDRX cycle, or the PTW may include multiple sub-time windows in the first eDRX cycle, two adjacent time windows in the multiple sub-time windows are discontinuous, and any sub-time window is a continuous time window. Optionally, the lengths of different sub-time windows in the multiple sub-time windows may be the same, or the lengths of some or all of the sub-time windows in the multiple sub-time windows may be different.

Optionally, in some embodiments, the PTW may be less than or equal to the predefined cycle. In some other embodiments, the PTW may be greater than the predefined cycle. Optionally, the PTW may be located at a predefined position in the first eDRX cycle. Illustratively, a position of the PTW in the first eDRX cycle may be determined based on the first eDRX parameter. For example, the first eDRX parameter includes the position of the PTW in the first eDRX cycle. The position of the PTW in the first eDRX cycle may also be determined based on a pre-configuration of the terminal device, or the position of the PTW in the first eDRX cycle may be configured by the first network device or the second network device for the terminal device, or the position of the PTW in the first eDRX cycle may be predefined by a protocol.

In some embodiments, whether the terminal device monitors the paging using the first eDRX parameter may include: whether the terminal device monitors the paging using the PTW, and/or whether the terminal device monitors the paging using the first eDRX cycle.

In some embodiments, the first eDRX cycle/parameter is an RAN eDRX cycle/parameter that is greater than the predefined cycle. In another embodiments, the first eDRX cycle/parameter is an eDRX cycle/parameter that is greater than the predefined cycle, where the eDRX cycle/parameter includes an RAN eDRX cycle/parameter and/or a CN eDRX cycle/parameter. In yet another embodiments, the first eDRX cycle/parameter is the CN eDRX cycle/parameter that is greater than the predefined cycle. Optionally, the predefined cycle may be predefined in a protocol, or the predefined cycle may be determined by the first network device based on a pre-configuration, or the predefined cycle may be configured by the second network device for the first network device. Optionally, the first network device may configure the predefined cycle for the terminal device.

Optionally, the paging in any of the embodiments of the disclosure may include a paging PDCCH or a paging PDSCH.

In the embodiments of the disclosure, the terminal device receives the first information from the first network device, and the terminal device determines whether to monitor the paging using the first eDRX parameter based on the first information. The first eDRX parameter includes the first eDRX cycle and/or the PTW, and the first eDRX cycle is greater than the predefined cycle. In this way, the terminal device determines whether to monitor the paging using the first eDRX parameter based on the first information, which can improve the flexibility of the terminal device when monitoring the paging. Moreover, when the terminal device monitors the paging using the first eDRX parameter, the first eDRX cycle in the first eDRX parameter is greater than the predefined cycle, thereby reducing the power consumption of the terminal device.

Optionally, in some other embodiments, the first eDRX parameter may be broadcast by the first network device to the terminal device. For example, the first network device may broadcast the first eDRX parameter, so that the terminal device may monitor the paging based on the first eDRX parameter broadcast by the first network device. In this way, when the terminal device moves to an area corresponding to a third network device, the terminal device may receive another eDRX parameter broadcast by the third network device, and the terminal device may monitor the paging based on the another eDRX parameter broadcast by the third network device. The another eDRX parameter may be the same as or different from the first eDRX parameter, and the another eDRX parameter may be greater than the predefined cycle or may be less than or equal to the predefined cycle. In this case, different network devices may determine the eDRX parameters based on their own pre-configuration, and the terminal device monitors the paging based on the eDRX parameter broadcast by the current serving cell.

FIG. 3 is a flowchart illustrating another communication method according to an embodiment of the disclosure. As illustrated in FIG. 3, the method includes the following operations.

At operation S301, a first network device sends first information to a terminal device.

At operation S302, the first network device determines whether to send a paging using a first eDRX parameter based on the first information. The first eDRX parameter includes a first eDRX cycle and/or a PTW, and the first eDRX cycle is greater than a predefined cycle. Optionally, an execution sequence of the operation S301 and the operation S302 is not limited by the embodiment of the disclosure.

Optionally, when the first information indicates that an eDRX supported by the first network device is greater than the predefined cycle, or when the first information indicates that the first network device supports an eDRX cycle greater than the predefined cycle, or when the first information indicates that the terminal device is allowed to use the eDRX cycle greater than the predefined cycle, or when the first information indicates that the terminal device configured with the eDRX greater than the predefined cycle is allowed to use the eDRX, the first network device may determine to send the paging using the first eDRX parameter.

Optionally, when the first information indicates that an eDRX supported by the first network device is not greater than the predefined cycle, or when the first information indicates that the first network device does not support an eDRX cycle greater than the predefined cycle, or when the first information indicates that the terminal device is not allowed to use the eDRX cycle greater than the predefined cycle, or when the first information indicates that the terminal device configured with the eDRX greater than the predefined cycle is not allowed to use the eDRX, the first network device may determine not to send the paging using the first eDRX parameter.

The first eDRX parameter may include a first RAN eDRX parameter. Optionally, regardless of whether the first network device sends the paging using the first RAN eDRX parameter, the first network device may send the paging using a CN eDRX and/or a paging DRX.

In some embodiments, whether the first network device sends the paging using the first eDRX parameter may include: whether the first network device sends the paging using the PTW, and/or whether the first network device sends the paging using the first eDRX cycle.

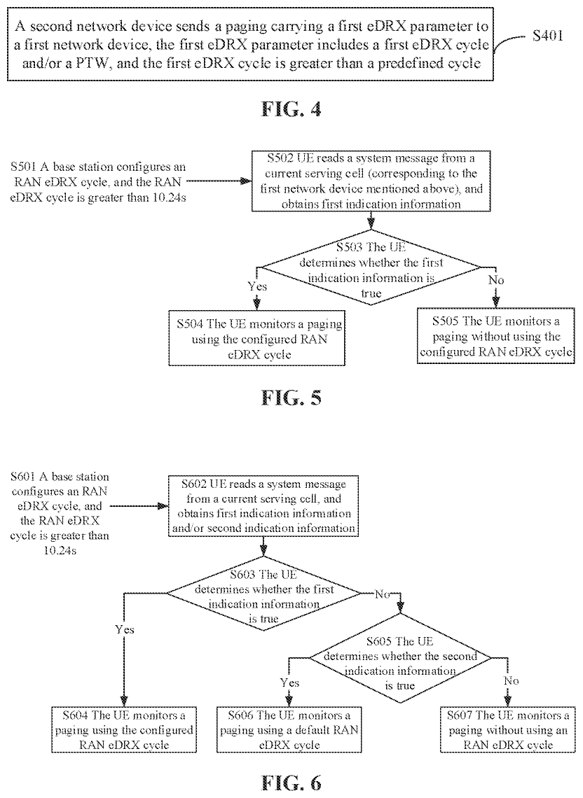

FIG. 4 is a flowchart illustrating yet another communication method according to an embodiment of the disclosure. As illustrated in FIG. 4, the method includes the following operation.

At operation S401, a second network device sends a paging carrying a first eDRX parameter to a first network device. The first eDRX parameter includes a first eDRX cycle and/or a PTW, and the first eDRX cycle is greater than a predefined cycle.

In the embodiment of the disclosure, the paging sent from the second network device to the first network device may carry the first eDRX parameter, and the first network device may send a paging to a terminal device using the first eDRX parameter or without using the first eDRX parameter. Optionally, in an implementation in which the first eDRX parameter is not used, an eDRX parameter may be determined based on a pre-configuration.

In some embodiments, the first information is sent to the terminal device from the first network device.

Optionally, the first information may be broadcast by the first network device to the terminal device. Optionally, the first information may be included in system information (SI). Optionally, the terminal device may be in an RRC disconnected state, and the terminal device may receive a broadcast message broadcast by the first network device.

In some embodiments, the first eDRX parameter is configured by a second network device for the terminal device. In some other embodiments, the first eDRX parameter is determined based on a pre-configuration. Optionally, the operation that the first eDRX parameter is determined based on the pre-configuration may include that: the first eDRX parameter is determined based on the pre-configuration of the terminal device, or the first eDRX parameter is determined by the terminal device based on the pre-configuration.

Optionally, the second network device may be a last network device that sends an RRC release message to the terminal device. The first eDRX parameter may be carried in the RRC release message.

In any embodiment of the disclosure, the RRC disconnected state may include the RRC inactive state or the RRC idle state.

Optionally, the first eDRX parameter may be a parameter predefined by a protocol. The pre-configuration of the terminal device may include a pre-configuration of the terminal device for configuring the first eDRX parameter, so that the terminal device may determine the first eDRX parameter based on the pre-configuration.

At the first network device side, in some embodiments, the first eDRX parameter is sent to the first network device from the second network device. In some other embodiments, the first eDRX parameter is determined by the first network device based on a pre-configuration. Optionally, the operation that the first eDRX parameter is determined by the first network device based on the pre-configuration may be understood as follows: the first eDRX parameter is determined based on a pre-configuration of the first network device.

In some embodiments, the method further includes the following operation. The terminal device receives an RRC release message from the second network device. The RRC release message carries the first eDRX parameter.

Optionally, the terminal device may initiate a request to switch from the RRC connected state to the RRC inactive state or the RRC idle state, the second network device may send the RRC release message to the terminal device based on the request, and the RRC release message carries the first eDRX parameter. In this way, the terminal device may monitor the paging sent by the second network device through the first eDRX parameter. Optionally, in some other embodiments, the second network device may actively initiate a procedure in which the terminal device switches from the RRC connected state to the RRC inactive state or the RRC idle state, so that the second network device sends the RRC release message to the terminal device, and the RRC release message carries the first eDRX parameter. Then, when the terminal device moves into an area corresponding to the first network device, the terminal device determines whether to monitor the paging using the first eDRX parameter based on the first information sent by the first network device.

In some embodiments, the first eDRX cycle is a first RAN eDRX cycle.

As such, the first RAN eDRX cycle may be an RAN eDRX cycle that is greater than the predefined cycle. Therefore, the terminal device may monitor the paging based on the RAN eDRX cycle greater than the predefined cycle, thereby reducing power consumption of the terminal device.

Optionally, the paging monitored by the terminal device may be determined by the first network device based on the paging sent by the second network device to the first network device. Optionally, the paging sent by the second network device to the first network device may carry the first eDRX cycle, and the first network device may send the paging based on the first eDRX cycle and the support or lack of support of the first network device for the eDRX cycle greater than the predefined cycle, so that the terminal device can monitor the paging.

In some other embodiments, the first eDRX cycle may be the eDRX cycle greater than the predefined cycle, or the first eDRX cycle may be the CN eDRX cycle greater than the predefined cycle.

In some embodiments, the first network device also needs to obtain the first eDRX parameter to send the paging through the first eDRX parameter. In some embodiments, the first eDRX parameter is send to the first network device from the second network device. In some other embodiments, the first eDRX parameter is determined by the first network device based on the pre-configuration. In yet other embodiments, the first eDRX parameter may be an eDRX parameter corresponding to the larger of: an RAN eDRX cycle sent by second network device to the first network device, and an RAN eDRX cycle determined by the first network device based on the pre-configuration; or the first eDRX parameter may be an eDRX parameter corresponding to the smaller of: the RAN eDRX cycle sent by second network device to the first network device, and the RAN eDRX cycle determined by the first network device based on the pre-configuration.

In some embodiments, the method further includes the following operation. The first network device receives the paging carrying the first eDRX parameter from the second network device. At the second network device side, the second network device sends the paging carrying the first eDRX parameter to the first network device.

Optionally, when the second network device obtains the paging for the terminal device, the second network device may send the paging carrying the first eDRX parameter to network devices in an RAN paging area, the network devices in the RAN paging area includes the first network device, and when the first network device receives the paging carrying the first eDRX parameter, the first network device send the paging to the terminal device based on the first eDRX parameter.

In some embodiments, the operation that the first network device receives the paging carrying the first eDRX parameter from the second network device includes the following operation. The first network device receives the paging carrying the first eDRX parameter from the second network device when the first information sent by the first network device to the second network device indicates that: the terminal device is allowed to monitor the paging using the RAN eDRX cycle greater than the predefined cycle, or indicates that a terminal device configured with the first eDRX cycle greater than the predefined cycle is allowed to monitor the paging using the eDRX.

At the second network device side, the operation that the second network device sends the paging carrying the first eDRX parameter to the first network device includes the following operation. The second network device sends the paging carrying the first eDRX parameter to the first network device when the first information received by the second network device from the first network device indicates that: the terminal device is allowed to monitor the paging using the RAN eDRX cycle greater than the predefined cycle, or indicates that the terminal device configured with the first eDRX cycle greater than the predefined cycle is allowed to monitor the paging using the eDRX.

In some embodiments, the first network device may actively send the first information to the second network device, to indicate whether the RAN eDRX cycle greater than the predefined cycle is supported, such that the second network device may send the paging carrying the first eDRX parameter to the first network device when the first network device supports the RAN eDRX cycle greater than the predefined cycle.

Optionally, in some embodiments, the first network device may periodically send the first information to the second network device. Optionally, in some other embodiments, the first network device may send the first information to the second network device when the supported RAN eDRX changes.

In some other embodiments, the second network device may send a request to the network devices in the RAN paging area to enable the first network device among the network devices in the RAN paging area to send the first information to the second network device, and the first information indicates whether the first network device supports the RAN eDRX cycle greater than the predefined cycle. The second network device may send the paging carrying the first eDRX parameter to the first network device when the first network device supports the RAN eDRX cycle greater than the predefined cycle.

In any embodiment of the disclosure, the operation that the terminal device monitors the paging without using the first eDRX parameter includes one of the following operations. The terminal device monitors the paging without using an RAN eDRX cycle. The terminal device monitors the paging without using an eDRX cycle. The terminal device monitors the paging using a second eDRX parameter. The terminal device monitors the paging without using the first eDRX parameter and the second eDRX parameter. The terminal device monitors the paging using a predefined eDRX cycle. Herein, the second eDRX parameter includes a second eDRX cycle, and the second eDRX cycle is less than or equal to the predefined cycle.

Optionally, the second DRX parameter may include a second RAN eDRX parameter. Optionally, the second eDRX cycle may include a second RAN eDRX cycle.

Optionally, the predefined eDRX cycle may be an eDRX cycle pre-configured in the terminal device. Optionally, the predefined eDRX cycle may be greater than the predefined cycle, or the predefined eDRX cycle may be less than or equal to the predefined cycle. Optionally, the predefined eDRX cycle may include a predefined RAN eDRX cycle and/or a predefined CN eDRX cycle. Thus, when terminal device does not monitor the paging using the first eDRX parameter, the terminal device monitors the paging using the predefined eDRX cycle.

In any embodiment of the disclosure, the operation that the terminal device monitors the paging without using the first eDRX parameter includes that: the terminal device monitors the paging using a CN eDRX cycle and/or a DRX cycle. Optionally, the method for monitoring the paging using the DRX cycle may refer to the description in the related art, which will not be repeated here.

In any embodiment of the disclosure, the operation that the terminal device monitors the paging without using the RAN eDRX cycle or the operation that the terminal device monitors the paging without using the first eDRX parameter and the second eDRX parameter includes that: the terminal device monitors the paging using a CN eDRX cycle and/or a DRX cycle.

In any embodiment of the disclosure, the operation that the terminal device monitors the paging without using the eDRX cycle includes that: the terminal device monitors the paging using the DRX cycle.

In some implementations, when monitoring the paging without using the first eDRX parameter, the terminal device may monitor the paging using the second eDRX parameter, and/or may monitor the paging using the CN eDRX cycle and/or the DRX cycle. When monitoring the paging without using the first eDRX parameter and the second eDRX parameter, the paging is monitored using the CN eDRX cycle and/or the DRX cycle.

At the first network device side, in any embodiment of the disclosure, the operation that the first network device sends the paging without using the first eDRX parameter includes one of the following operations. The first network device sends the paging without using an RAN eDRX cycle. The first network device sends the paging without using an eDRX cycle. The first network device sends the paging using a second eDRX parameter. The first network device sends the paging without using the first eDRX parameter and the second eDRX parameter. The first network device sends the paging using a predefined eDRX cycle. Herein, the second eDRX parameter includes a second eDRX cycle, and the second eDRX cycle is less than or equal to the predefined cycle.

Optionally, the predefined eDRX cycle may be an eDRX cycle pre-configured by the first network device. Optionally, the eDRX cycle pre-configured by the first network device may be the same as or different from the eDRX cycle pre-configured by the terminal device. Optionally, the predefined eDRX cycle may be greater than the predefined cycle, or the predefined eDRX cycle may be less than or equal to the predefined cycle. Optionally, the predefined eDRX cycle may include a predefined RAN eDRX cycle and/or a predefined CN eDRX cycle. Thus, when the first network device does not send the paging using the first eDRX parameter, the first network device sends the paging using the predefined eDRX cycle.

In any embodiment of the disclosure, the operation that the first network device sends the paging without using the first eDRX parameter includes that: the first network device sends the paging using a CN eDRX cycle and/or a DRX cycle. Optionally, the method for sending the paging using the DRX cycle may refer to the description in the related art, which will not be repeated here.

In any embodiment of the disclosure, the operation that the first network device sends the paging without using the RAN eDRX cycle or the first network device sends the paging without using the first eDRX parameter and the second eDRX parameter includes that: the first network device sends the paging using a CN eDRX cycle and/or a DRX cycle.

In any embodiment of the disclosure, the operation that the first network device sends the paging without using the eDRX cycle includes that: the first network device sends the paging using the DRX cycle.

In some implementations, when sending the paging without using the first eDRX parameter, the first network device may send the paging using the second eDRX parameter, and/or send the paging using the CN eDRX cycle and/or the DRX cycle. When sending the paging without using the first eDRX parameter and the second eDRX parameter, the paging is sent using the CN eDRX cycle and/or the DRX cycle.

In some embodiments, the first information indicates that the terminal device is allowed to monitor the paging using an RAN eDRX cycle greater than the predefined cycle.

Alternatively, the first information indicates that the terminal device is not allowed to monitor the paging using the RAN eDRX cycle greater than the predefined cycle.

As such, the terminal device may determine whether to monitor the paging using the first eDRX parameter based on the first information, which indicates whether the terminal device is allowed to monitor the paging using the RAN eDRX cycle greater than the predefined cycle.

In some embodiments, the operation that the terminal device determines whether to monitor the paging using the first eDRX parameter based on the first information includes the following operation.

When the terminal device is configured with the first eDRX parameter, and when the first information indicates that the terminal device is allowed to monitor the paging using an RAN eDRX cycle greater than the predefined cycle, the terminal device monitors the paging using the first eDRX parameter. Optionally, the terminal device may further monitor the paging using a CN eDRX and/or a paging DRX.

In some embodiments, the first eDRX parameter may be configured by a second network device for the terminal device. In some other embodiments, the first eDRX parameter may be determined by the terminal device based on a pre-configuration. In yet other embodiments, the first eDRX parameter may be configured by the first network device for the terminal device. The first eDRX parameter configured by the first network device for the terminal device may be sent by the second network device, or may be determined based on a pre-configuration of the first network device. In still other embodiments, the first eDRX parameter may be predefined by a protocol.

At the first network device side, the operation that the first network device determines whether to send the paging using the first eDRX parameter based on the first information includes that: when a second network device configures the first eDRX parameter for the first network device, and when the first information indicates that the terminal device is allowed to monitor the paging using an RAN eDRX cycle greater than the predefined cycle, the first network device sends the paging using the first eDRX parameter.

In such embodiment, the first eDRX parameter obtained by the first network device is configured by the second network device. In some other embodiments, the first eDRX parameter obtained by the first network device may be predefined by a protocol or may be determined based on a pre-configuration of the first network device.

In some embodiments, the operation that the terminal device determines whether to monitor the paging using the first eDRX parameter based on the first information includes that: when the terminal device is configured with the first eDRX parameter, and when the first information indicates that the terminal device is not allowed to monitor the paging using an RAN eDRX cycle greater than the predefined cycle, the terminal device monitors the paging without using the first eDRX parameter.

At the first network device side, the operation that the first network device determines whether to send the paging using the first eDRX parameter based on the first information includes that: when a second network device configures the first eDRX parameter for the first network device, and when the first information indicates that the terminal device is not allowed to monitor the paging using an RAN eDRX cycle greater than the predefined cycle, the first network device sends the paging without using the first eDRX parameter.

In some embodiments, the operation that the terminal device monitors the paging without using the first eDRX parameter includes that: a behavior of the terminal device for monitoring the paging is the same as a behavior when an RAN eDRX is not configured. Optionally, the terminal device may also monitor the paging using the CN eDRX cycle and/or the DRX cycle. Optionally, the behavior of the terminal device for monitoring the paging is the same as the behavior when the RAN eDRX is not configured, which may be the same as the embodiment in which the terminal device monitors the paging without using the RAN eDRX cycle.

In such embodiment, the behavior of the terminal device for monitoring the paging may be as follows: the terminal device monitors the paging through other parameters for monitoring the paging than the RAN eDRX, and/or the terminal device monitors the paging based on an RAN eDRX parameter that is not configured by the second network device. Herein, the other parameters for monitoring the paging may include the CN eDRX and/or the paging DRX.

In any embodiment of the disclosure, the paging DRX may be understood to be the same as the DRX or the DRX cycle. In any embodiment of the disclosure, the eDRX may be understood to be the same as the eDRX cycle, the RAN eDRX may be understood to be the same as the RAN eDRX cycle, and the CN eDRX may be understood to be the same as the CN eDRX cycle.

At the first network device side, the operation that the first network device sends the paging without using the first eDRX parameter includes that: a behavior of the first network device for sending the paging is the same as a behavior when an RAN eDRX is not configured. Optionally, the first network device may also send the paging using the CN eDRX cycle and/or the DRX cycle. Optionally, the behavior of the first network device for sending the paging is the same as the behavior when an RAN eDRX is not configured, which may be understood in the same way as sending the paging by the first network device without using the RAN eDRX cycle.

In such embodiment, the behavior of the first network device for sending the paging may be as follows: the first network device sends the paging through other parameters for sending the paging than the RAN eDRX, and/or the first network device sends the paging based on an RAN eDRX parameter that is not configured by the second network device. Herein, the other parameters for sending the paging may include the CN eDRX and/or the paging DRX.

In some embodiments, the operation that the terminal device monitors the paging without using the first eDRX parameter includes that: the terminal device monitors the paging using a second eDRX parameter. The second eDRX parameter includes a second eDRX cycle, and the second eDRX cycle is less than or equal to the predefined cycle.

In such embodiment, the terminal device will monitor the paging using an eDRX cycle less than or equal to the predefined cycle. Optionally, the terminal device may also monitor the paging using the CN eDRX and/or the paging DRX. Optionally, the behavior of the first network device for sending the paging is the same as the behavior when the RAN eDRX is not configured, which may be the same as the embodiment in which the first network device sending the paging without using the RAN eDRX cycle.

In some embodiments, the second eDRX parameter may be predefined by a protocol. In some other embodiments, the second eDRX parameter may be configured by the second network device for the terminal device. In still other embodiments, the second eDRX parameter may be configured by the first network device for the terminal device. Herein, the second eDRX parameter configured by the first network device for the terminal device may be determined based on a pre-configuration of the first network device, or may be sent by the second network device. In still some embodiments, the second eDRX parameter may be determined by the terminal device based on a pre-configuration.

Optionally, in any embodiment of the disclosure, the second eDRX parameter/cycle may include a second RAN eDRX parameter/cycle.

In some embodiments, the operation that the terminal device monitors the paging without using the first eDRX parameter includes that: the terminal device monitors the paging without using the first eDRX parameter and the second eDRX parameter.

In such embodiment, the terminal device will monitor the paging using the CN eDRX and/or the paging DRX. For example, the terminal device will monitor the paging only using the CN eDRX. For another example, the terminal device will monitor the paging only using the paging DRX. For yet another example, the terminal device will monitor the paging using both the CN eDRX and the paging DRX.

In any embodiment of the disclosure, the paging monitored by the terminal device through the paging DRX may be determined and sent by the first network device based on a paging received from the second network device, and/or may be determined and sent by the first network device based on a paging received from the core network device.

At the first network device side, the operation that the first network device sends the paging without using the first eDRX parameter includes that: the first network device sends the paging using a second eDRX parameter.

In such embodiment, the first network device will send the paging using an eDRX cycle less than or equal to the predefined cycle (i.e., the second eDRX parameter). Optionally, the first network device may also sends the paging using the CN eDRX and/or the paging DRX.

In some embodiments, the second eDRX parameter may be predefined by a protocol. In some other embodiments, the second eDRX parameter may be configured by the second network device for the first network device. In yet other embodiments, the second eDRX parameter may be determined by the first network device based on a pre-configuration.

In some embodiments, the operation that the first network device sends the paging without using the first eDRX parameter includes that: the first network device sends the paging without using the first eDRX parameter and the second eDRX parameter.

In such embodiment, the first network device will send the paging using the CN eDRX and/or the paging DRX. For example, the first network device will send the paging only using the CN eDRX. For another example, the first network device will send the paging only using the paging DRX. For yet another example, the first network device will send the paging using both the CN eDRX and the paging DRX.

In some embodiments, the method further includes that: the terminal device receives second information from the first network device. The second information indicates whether the terminal device is allowed to monitor the paging using an RAN eDRX, or indicates whether the terminal device is allowed to monitor the paging using an RAN eDRX cycle less than or equal to the predefined cycle.

In some embodiments, the operation that the terminal device determines whether to monitor the paging using the first eDRX parameter based on the first information includes that: the terminal device determines whether to monitor the paging using the first eDRX parameter based on the first information and the second information. In this way, the terminal device can determine parameters for monitoring the paging based on both the first information and the second information.

In some embodiments, when the first information indicates that the terminal device is allowed to monitor the paging using the RAN eDRX cycle greater than the predefined cycle, regardless of what information the second information indicates, the terminal device will monitor the paging using the first eDRX parameter. In some other embodiments, when the first information indicates that the terminal device is allowed to monitor the paging using the RAN eDRX cycle greater than the predefined cycle, and when the second information indicates that the terminal device is not allowed to monitor the paging using the RAN eDRX/eDRX, the terminal device monitors the paging without using the RAN eDRX/eDRX. In still other embodiments, when the first information indicates that the terminal device is allowed to monitor the paging using the RAN eDRX cycle greater than the predefined cycle, and when the second information indicates that the terminal device is allowed to monitor the paging using the RAN eDRX, the terminal device monitors the paging using the first eDRX parameter.

In some embodiments, when the first information indicates that the terminal device is not allowed to monitor the paging using the RAN eDRX cycle greater than the predefined cycle, regardless of what information the second information indicates, the terminal device does not monitor the paging using the first eDRX parameter.

Optionally, the terminal device may determine whether to monitor the paging using the first eDRX parameter based on the first information, and when it is determined to monitor the paging without using the first eDRX parameter, the terminal device may determine the parameters for monitoring the paging based on the second information. For example, the terminal device may determine whether to monitor the paging using the second eDRX parameter.

At the first network device side, the method further includes that: the first network device sends second information to the terminal device. The second information indicates whether the terminal device is allowed to monitor the paging using an RAN eDRX, or indicates whether the terminal device is allowed to monitor the paging using an RAN eDRX cycle less than or equal to the predefined cycle.

In some embodiments, the operation that the first network device determines whether to send the paging using the first eDRX parameter based on the first information includes that: the first network device determines whether to send the paging using the first eDRX parameter based on the first information and the second information.

In this way, the first network device can determine parameters for sending the paging based on both the first information and the second information.

In some embodiments, when the first information indicates that the terminal device is allowed to monitor the paging using the RAN eDRX cycle greater than the predefined cycle, regardless of what information the second information indicates, the first network device sends the paging using the first eDRX parameter. In other embodiments, when the first information indicates that the terminal device is allowed to monitor the paging using the RAN eDRX cycle greater than the predefined cycle, and when the second information indicates that the terminal device is not allowed to monitor the paging using the RAN eDRX/eDRX, the first network device sends the paging without using the RAN eDRX/eDRX. In still other embodiments, when the first information indicates that the terminal device is allowed to monitor the paging using the RAN eDRX cycle greater than the predefined cycle, and when the second information indicates that the terminal device is allowed to monitor the paging using the RAN eDRX, the first network device sends the paging using the first eDRX parameter.

In some embodiments, when the first information indicates that the terminal device is not allowed to monitor the paging using the RAN eDRX cycle greater than the predefined cycle, regardless of what information the second information indicates, the first network device does not send the paging using the first eDRX parameter.

Optionally, the first network device may determine whether to send the paging using the first eDRX parameter based on the first information, and when it is determined to send the paging without using the first eDRX parameter, the first network device may determine the parameters for sending the paging based on the second information. For example, the first network device may determine whether to send the paging using the second eDRX parameter.

In some embodiments, the method further includes that: the terminal device receives second information from the first network device.

When the terminal device is configured with the first eDRX parameter, and the first information indicates that the terminal device is not allowed to monitor the paging using the RAN eDRX cycle greater than the predefined cycle, the terminal device monitors the paging without using the first eDRX parameter, which includes the following operation. When the terminal device is configured with the first eDRX parameter, the first information indicates that the terminal device is not allowed to monitor the paging using the RAN eDRX cycle greater than the predefined cycle, and when the second information indicates that: the terminal device is allowed to monitor the paging using an RAN eDRX or the terminal device is allowed to monitor the paging using an RAN eDRX cycle less than or equal to the predefined cycle, the terminal device monitors the paging using a second eDRX parameter. The second eDRX parameter includes a second eDRX cycle, and the second eDRX cycle is less than or equal to the predefined cycle.

In this case, the terminal device monitors the paging without using the first eDRX parameter.

Optionally, the second eDRX cycle may be a second RAN eDRX cycle. Optionally, the second RAN eDRX cycle may be an RAN eDRX cycle that is less than or equal to the predefined cycle.

In such embodiment, the terminal device may monitor the paging without using the first eDRX parameter, but may monitor the paging using the second eDRX parameter. Optionally, the terminal device may further monitor the paging using the CN eDRX and/or the paging DRX.

At the first network device side, the method further includes that: the first network device sends second information to the terminal device.

When the second network device configures the first eDRX parameter for the first network device, and the first information indicates that the terminal device is not allowed to monitor the paging using the RAN eDRX cycle greater than the predefined cycle, the first network device send the paging without using the first eDRX parameter, which includes the following operation. When the second network device configures the first eDRX parameter for the first network device, the first information indicates that the terminal device is not allowed to monitor the paging using the RAN eDRX cycle greater than the predefined cycle, and when the second information indicates that: the terminal device is allowed to monitor the paging using an RAN eDRX or the terminal device is allowed to monitor the paging using an RAN eDRX cycle less than or equal to the predefined cycle, the first network device sends the paging using a second eDRX parameter. The second eDRX parameter includes a second eDRX cycle, and the second eDRX cycle is less than or equal to the predefined cycle.

In such embodiment, the first network device may send the paging without using the first eDRX parameter, but may send the paging using the second eDRX parameter. Optionally, the first network device may further send the paging using the CN eDRX and/or the paging DRX.

In some embodiments, the method further includes that: the terminal device receives second information from the first network device.

When the terminal device is configured with the first eDRX parameter, and the first information indicates that the terminal device is not allowed to monitor the paging using the RAN eDRX cycle greater than the predefined cycle, the terminal device monitors the paging without using the first eDRX parameter, which includes the following operation. When the terminal device is configured with the first eDRX parameter, the first information indicates that the terminal device is not allowed to monitor the paging using the RAN eDRX cycle greater than the predefined cycle, and when the second information indicates that: the terminal device is not allowed to monitor the paging using an RAN eDRX or the terminal device is not allowed to monitor the paging using an RAN eDRX cycle less than or equal to the predefined cycle, the terminal device monitors the paging without using the RAN eDRX cycle, or the terminal device monitors the paging without using the first eDRX parameter and a second eDRX parameter. The second eDRX parameter includes a second eDRX cycle, and the second eDRX cycle is less than or equal to the predefined cycle.

In such embodiment, the terminal device monitors the paging neither using the first eDRX parameter, nor using the second eDRX parameter. Optionally, the terminal device may monitor the paging using the CN eDRX and/or the paging DRX.

At the first network device side, the method further includes that: the first network device sends second information to the terminal device.

When the second network device configures the first eDRX parameter for the first network device, and the first information indicates that the terminal device is not allowed to monitor the paging using the RAN eDRX cycle greater than the predefined cycle, the first network device send the paging without using the first eDRX parameter, which includes the following operation. When the second network device configures the first eDRX parameter for the first network device, the first information indicates that the terminal device is not allowed to monitor the paging using the RAN eDRX cycle greater than the predefined cycle, and when the second information indicates that: the terminal device is not allowed to monitor the paging using an RAN eDRX or the terminal device is not allowed to monitor the paging using an RAN eDRX cycle less than or equal to the predefined cycle, the first network device sends the paging without using the RAN eDRX cycle, or the first network device sends the paging without using the first eDRX parameter and a second eDRX parameter. The second eDRX parameter includes a second eDRX cycle, and the second eDRX cycle is less than or equal to the predefined cycle.

In such embodiment, the first network device sends the paging neither using the first eDRX parameter, nor using the second eDRX parameter. Optionally, the first network device may send the paging using the CN eDRX and/or the paging DRX.

In any embodiment of the disclosure, the CN eDRX cycle may be greater than the predefined cycle, or the CN eDRX cycle may be less than or equal to the predefined cycle, and the embodiment of the disclosure is not limited thereto.

In some embodiments, the first information indicates that a terminal device configured with the first eDRX cycle greater than the predefined cycle is allowed to monitor the paging using an eDRX. Optionally, the first information indicates that the terminal device configured with the first eDRX cycle greater than the predefined cycle is not allowed to monitor the paging using the eDRX.

In this way, the terminal device may determine whether to monitor the paging using the first eDRX parameter based on the first information, which indicates whether the terminal device configured with the first eDRX cycle greater than the predefined cycle is allowed to monitor the paging using the eDRX. In some other embodiments, the first information may indicate whether the terminal device configured with the eDRX cycle greater than the predefined cycle is allowed to monitor the paging using the eDRX. In still other embodiments, the first information may indicate whether the terminal device configured with the eDRX cycle greater than the predefined cycle is allowed to monitor the paging using the eDRX greater than the predefined cycle.

In some embodiments, the operation that the terminal device determines whether to monitor the paging using the first eDRX parameter based on the first information includes that: when the terminal device is configured with the first eDRX parameter, and the first information indicates that the terminal device configured with the first eDRX cycle greater than the predefined cycle is allowed to monitor the paging using an eDRX, the terminal device monitors the paging using the first eDRX parameter.

At the first network device side, in some embodiments, the operation that the first network device determines whether to send the paging using the first eDRX parameter based on the first information includes that: when a second network device configures the first eDRX parameter for the first network device, and the first information indicates that the terminal device configured with the first eDRX cycle greater than the predefined cycle is allowed to monitor the paging using an eDRX, the first network device sends the paging using the first eDRX parameter.

In some embodiments, the operation that the terminal device determines whether to monitor the paging using the first eDRX parameter based on the first information includes that: when the terminal device is configured with the first eDRX parameter, and the first information indicates that the terminal device configured with the first eDRX cycle greater than the predefined cycle is not allowed to monitor the paging using an eDRX, the terminal device monitors the paging without using the first eDRX parameter.

At the first network device side, in some embodiments, the operation that the first network device determines whether to send the paging using the first eDRX parameter based on the first information includes that: when a second network device configures the first eDRX parameter for the first network device, and the first information indicates that the terminal device configured with the first eDRX cycle greater than the predefined cycle is not allowed to monitor the paging using an eDRX, the first network device sends the paging without using the first eDRX parameter.

In some embodiments, the operation that the terminal device monitors the paging without using the first eDRX parameter includes that: a behavior of the terminal device for monitoring the paging is the same as a behavior when the eDRX is not configured.

At the first network device side, in some embodiments, the operation that the first network device sends the paging without using the first eDRX parameter includes that: a behavior of the first network device for sending the paging is the same as a behavior when the eDRX is not configured.

In some embodiments, the method further includes that: the terminal device receives second information from the first network device. The second information indicates whether the terminal device is allowed to monitor the paging using the eDRX.

In some embodiments, the operation that the terminal device determines whether to monitor the paging using the first eDRX parameter based on the first information includes that: the terminal device determines whether to monitor the paging using the first eDRX parameter based on the first information and the second information. In this way, the terminal device can determine parameters for monitoring the paging based on both the first information and the second information.

In some embodiments, when the first information indicates that the terminal device configured with the first eDRX cycle greater than the predefined cycle is allowed to monitor the paging using the eDRX, regardless of what information the second information indicates, the terminal device monitors the paging using the first eDRX parameter. In some other embodiment, when the first information indicates that terminal device configured with the first eDRX cycle greater than the predefined cycle is allowed to monitor the paging using the eDRX, and when the second information indicates that the terminal device is not allowed to monitor the paging using the eDRX, the terminal device monitors the paging without using the eDRX. In still other embodiments, when the first information indicates that the terminal device configured with the first eDRX cycle greater than the predefined cycle is allowed to monitor the paging using the eDRX, and when the second information indicates that the terminal device is allowed to monitor the paging using the eDRX, the terminal device monitors the paging using the first eDRX parameter.

In some embodiments, when the first information indicates that the terminal device configured with the first eDRX cycle greater than the predefined cycle is not allowed to monitor the paging using the eDRX, regardless of what information the second information indicates, the terminal device monitors the paging without using the first eDRX parameter.

Optionally, the terminal device may determine whether to monitor the paging using the first eDRX parameter based on the first information, and when it is determined to monitor the paging without using the first eDRX parameter, the terminal device may determine the parameters for monitoring the paging based on the second information. For example, the terminal device may determine whether to monitor the paging using the second eDRX parameter.

At the first network device side, in some embodiments, the method further includes that: the first network device sends second information to the terminal device. The second information indicates whether the terminal device is allowed to monitor the paging using the eDRX.

In some embodiments, the operation that the first network device determines whether to send the paging using the first eDRX parameter based on the first information includes that: the first network device determines whether to send the paging using the first eDRX parameter based on the first information and the second information.

In this way, the first network device can determine parameters for sending the paging based on both the first information and the second information.

In some embodiments, when the first information indicates that the terminal device configured with the first eDRX cycle greater than the predefined cycle is allowed to monitor the paging using the eDRX, regardless of what information the second information indicates, the first network device sends the paging using the first eDRX parameter. In some other embodiments, when the first information indicates that the terminal device configured with the first eDRX cycle greater than the predefined cycle is allowed to monitor the paging using the eDRX, and when the second information indicates that the terminal device is not allowed to monitor the paging using the eDRX, the first network device sends the paging without using the eDRX. In still other embodiments, when the first information indicates that the terminal device configured with the first eDRX cycle greater than the predefined cycle is allowed to monitor the paging using the eDRX, and when the second information indicates that the terminal device is allowed to monitor the paging using the eDRX, the first network device sends the paging using the first eDRX parameter.

In some embodiments, when the first information indicates that the terminal device configured with the first eDRX cycle greater than the predefined cycle is not allowed to monitor the paging using the eDRX, regardless of what information the second information indicates, the first network device sends the paging without using the first eDRX parameter.

Optionally, the first network device may determine whether to send the paging using the first eDRX parameter based on the first information, and when it is determined to send the paging without using the first eDRX parameter, the first network device may determine the parameters for sending the paging based on the second information. For example, the first network device may determine whether to send the paging using the second eDRX parameter.

In some embodiments, the method further includes that: the terminal device receives second information from the first network device.

When the terminal device is configured with the first eDRX parameter, and the first information indicates that the terminal device configured with the first eDRX cycle greater than the predefined cycle is not allowed to monitor the paging using the eDRX, the terminal device monitors the paging without using the first eDRX parameter, which includes the following operation. When the terminal device is configured with the first eDRX parameter, the first information indicates that the terminal device configured with the first eDRX cycle greater than the predefined cycle is not allowed to monitor the paging using the eDRX, and when the second information indicates that the terminal device is allowed to monitor the paging using the eDRX, the terminal device monitors the paging using a second eDRX parameter and/or a CN eDRX cycle. The second eDRX parameter includes a second RAN eDRX cycle, and the second RAN eDRX cycle is less than or equal to the predefined cycle.

At the first network device side, in some embodiments, the method further includes that: the first network device sends second information to the terminal device.

When the second network device configures the first eDRX parameter for the first network device, and the first information indicates that the terminal device configured with the first eDRX cycle greater than the predefined cycle is not allowed to monitor the paging using the eDRX, the first network device send the paging without using the first eDRX parameter, which includes the following operation. When the second network device configures the first eDRX parameter for the first network device, and the first information indicates that the terminal device configured with the first eDRX cycle greater than the predefined cycle is not allowed to monitor the paging using the eDRX, and when the second information indicates that the terminal device is allowed to monitor the paging using the eDRX, the first network device sends the paging using a second eDRX parameter and/or a CN eDRX cycle. The second eDRX parameter includes a second eDRX cycle, and the second eDRX cycle is less than or equal to the predefined cycle.

In some embodiments, the method further include that: the terminal device receives second information from the first network device.

When the terminal device is configured with the first eDRX parameter, and the first information indicates that the terminal device configured with the first eDRX cycle greater than the predefined cycle is not allowed to monitor the paging using the eDRX, the terminal device monitors the paging without using the first eDRX parameter, which includes the following operation. When the terminal device is configured with the first eDRX parameter, the first information indicates that the terminal device configured with the first eDRX cycle greater than the predefined cycle is not allowed to monitor the paging using the eDRX, and when the second information indicates that the terminal device is not allowed to monitor the paging using the eDRX, the terminal device monitors the paging without using an eDRX cycle.

In such embodiment, the operation that the terminal device monitors the paging without using the eDRX may include that: the terminal device monitors the paging without using any eDRX. Illustratively, the operation that the terminal device monitors the paging without using any eDRX may include that: the terminal device monitors the paging without using the RAN eDRX, and/or the terminal device monitors the paging without using the CN eDRX. For example, the terminal device monitors the paging neither using the RAN eDRX nor using the CN eDRX.

At the first network device side, in some embodiments, the method further includes that: the first network device sends second information to the terminal device.

When the second network device configures the first eDRX parameter for the first network device, and the first information indicates that the terminal device configured with the first eDRX cycle greater than the predefined cycle is not allowed to monitor the paging using the eDRX, the first network device send the paging without using the first eDRX parameter, which includes the following operation. When the second network device configures the first eDRX parameter for the first network device, the first information indicates that the terminal device configured with the first eDRX cycle greater than the predefined cycle is not allowed to monitor the paging using the eDRX, and when the second information indicates that the terminal device is not allowed to monitor the paging using the eDRX, the first network device sends the paging without using an eDRX cycle.

In such embodiment, the operation that the first network device sends the paging without using the eDRX may include that: the first network device sends the paging without using any eDRX. Illustratively, the operation that the first network device sends the paging without using any eDRX may include that: the first network device sends the paging without using the RAN eDRX, and/or the first network device sends the paging without using the CN eDRX. For example, the first network device sends the paging neither using the RAN eDRX nor using the CN eDRX.

Optionally, the operation that the terminal device monitors the paging without using the eDRX cycle may be understood as a behavior of the terminal device for monitoring the paging without configuring the eDRX. The operation that the first network device sends the paging without using the eDRX cycle may be understood as a behavior of the first network device for sending the paging without configuring the eDRX.

In some embodiments, the second eDRX parameter is predefined by a protocol. In some other embodiments, the second eDRX parameter is determined by the terminal device based on a pre-configuration. In yet other embodiments, the second eDRX parameter is sent by the first network device.

In some embodiments, the terminal device may receive an eDRX cycle less than the predefined cycle from the second network device; and the terminal device may determine another eDRX cycle less than the predefined cycle based on a pre-configuration. The parameter corresponding to the larger of the two eDRX cycles is determined as the second eDRX parameter, or the parameter corresponding to the smaller of the two eDRX cycles is determined as the second eDRX parameter.

From a perspective of the first network device side, in some embodiments, the second eDRX parameter is predefined by a protocol. In some other embodiments, the second eDRX parameter is determined by the first network device based on a pre-configuration.

In some embodiments, the second eDRX parameter is sent to the terminal device from the second network device.

From the perspective of the first network device side, in some embodiments, the second eDRX parameter is sent to the first network device from the second network device.

In some embodiments, the first network device may receive an eDRX cycle less than the predefined cycle from the second network device; and the first network device may determine another eDRX cycle less than the predefined cycle based on a pre-configuration. The parameter corresponding to the larger of the two eDRX cycles is determined as the second eDRX parameter, or the parameter corresponding to the smaller of the two eDRX cycles is determined as the second eDRX parameter.

In some embodiments, the method further includes that: the terminal device receives an RRC release message from the second network device. The RRC release message carries the second eDRX parameter. In some embodiments, the terminal device enters the INACTIVE state or the IDLE state after receiving the RRC release message.

In some embodiments, the terminal device is in an inactive state. In some other embodiments, the terminal device is in an idle state. Thus, there is no connection between the terminal device and the network device in the inactive state or idle state, and a paging is obtained by monitoring the paging.

An implementation for obtaining the second eDRX parameter by the first network device is described below.

In some embodiments, the method further includes that: the first network device receives a paging carrying the first eDRX parameter and the second eDRX parameter, or a paging carrying the second eDRX parameter from the second network device.

Optionally, when the second network device obtains the paging for the terminal device, the second network device may send the paging carrying the first eDRX parameter and the second eDRX parameter or the paging carrying the second eDRX parameter to the network devices in the RAN paging area, the network devices in the RAN paging area includes the first network device. When the first network device receives the paging carrying the first eDRX parameter and the second eDRX parameter or the paging carrying the second eDRX parameter, the first network device sends the paging using the second eDRX parameter if the first network device determines that it does not support the eDRX beyond the predefined cycle.

In some embodiments, the operation that the first network device receives the paging carrying the first eDRX parameter and the second eDRX parameter, or the paging carrying the second eDRX parameter from the second network device includes the following operation. When the first information sent to the second network device from the first network device indicates that the terminal device is not allowed to monitor the paging using the RAN eDRX cycle greater than the predefined cycle or indicates that the terminal device configured with the first eDRX cycle greater than the predefined cycle is not allowed to monitor the paging using the eDRX, the first network device receives, from the second network device, the paging carrying the first eDRX parameter and the second eDRX parameter or the paging carrying the second eDRX parameter.

In some embodiments, the first network device may actively send the first information to the second network device, and the first information indicates whether the RAN eDRX greater than the predefined cycle is supported by the first network device. The second network device may send the paging carrying the second eDRX parameter or the paging carrying the first eDRX parameter and the second eDRX parameter to the first network device when the first network device does not support the RAN eDRX greater than the predefined cycle, thereby enabling the first network device to obtain the second eDRX parameter and to send the paging using the second eDRX parameter.

From a perspective of the second network device, in some embodiments, the method further includes that: the second network device sends a paging carrying a second eDRX parameter or a paging carrying the first eDRX parameter and the second eDRX parameter, to the first network device. The second eDRX parameter includes a second eDRX cycle, and the second eDRX cycle is less than or equal to the predefined cycle.

In some embodiments, the operation that the second network device sends the paging carrying the second eDRX parameter or the paging carrying the first eDRX parameter and the second eDRX parameter, to the first network device includes the following operation.

When first information received by the second network device from the first network device indicates that a terminal device is not allowed to monitor a paging using an RAN eDRX cycle greater than the predefined cycle or indicates that a terminal device configured with the first eDRX cycle greater than the predefined cycle is not allowed to monitor the paging using an eDRX, the second network device sends the paging carrying the second eDRX parameter or the paging carrying the first eDRX parameter and the second eDRX parameter, to the first network device.

The following describes how the second network device configures the first eDRX parameter and/or the second eDRX parameter for the terminal device from the perspective of the second network device.

In some embodiments, the method further includes that: the second network device configures the first eDRX parameter and/or the second eDRX parameter for the terminal device. The first eDRX parameter and/or the second eDRX parameter are used for the terminal device to monitor a paging. The second eDRX parameter includes a second eDRX cycle, and the second eDRX cycle is less than or equal to the predefined cycle.

Optionally, the first eDRX parameter and the second eDRX parameter may be carried in the same signaling, or may be carried in different signaling.

In some embodiments, the operation that the second network device configures the first eDRX parameter and/or the second eDRX parameter for the terminal device includes that: the second network device sends an RRC release message to the terminal device. The RRC release message carries the first eDRX parameter and/or the second eDRX parameter.

In any embodiment of the disclosure, the predefined cycle may be 10.24 s. It should be noted that, in some other embodiments, the predefined cycle may be a value other than 10.24 s. For example, the predefined cycle may be less than 10.24 s, or the predefined cycle may be greater than 10.24 s. For example, the predefined cycle may be 5.12 s, 20.48 s, or the like, which is not limited by the embodiments of the disclosure.

In the embodiments of the disclosure, the terminal device receives the first information from the first network device, and the terminal device determines whether to monitor the paging using the first eDRX parameter based on the first information. The first eDRX parameter includes the first eDRX cycle and/or the PTW, and the first eDRX cycle is greater than the predefined cycle. In this way, the terminal device determines whether to monitor the paging using the first eDRX parameter based on the first information, which can improve the flexibility of the terminal device when monitoring the paging. Moreover, when the terminal device monitors the paging using the first eDRX parameter, the first eDRX cycle in the first eDRX parameter is greater than the predefined cycle, thereby reducing the power consumption of the terminal device.

The implementation of the communication method of the disclosure is described from the following embodiments.

In some embodiments, when the RAN eDRX cycle configured by the base station (in any embodiment of the disclosure, unless otherwise specified, the base station may correspond to the first network device or the second network device mentioned above) for the UE (corresponding to the terminal device mentioned above) is greater than 10.24 s, the UE determines whether to monitor the paging using the configured RAN eDRX cycle based on indication information, of “whether the UE in the RRC_INACTIVE state (i.e., RRC_INACTIVE UE) is allowed to use a (RAN) eDRX cycle exceeding 10.24 s”, broadcast by the current serving cell. When the indication information is “not allowed”, the UE monitors the paging without using the RAN eDRX cycle. In any embodiment of the disclosure, the (RAN) eDRX may represent the eDRX or the RAN eDRX. The specific implementation process is as follows.

First of all, when releasing the UE to the RRC_INACTIVE state (corresponding to the INACTIVE state mentioned above), the base station configures an RAN eDRX cycle for the UE through the RRC release message.

Secondly, the UE in the INACTIVE state receives a system message broadcast by the serving cell (corresponding to the first network device mentioned above). The system message includes indication information about the eDRX, and may specifically include first indication information and/or second indication information.

The first indication information (corresponding to the first information mentioned above) indicates whether the UE in the RRC INACTTIVE state is allowed to use the (RAN) eDRX cycle exceeding 10.24 s in the cell.

The second indication information (corresponding to the second information mentioned above) indicates whether the UE in the RRC INACTTIVE state is allowed to use the (RAN) eDRX in the cell or is allowed to use a (RAN) eDRX cycle not exceeding 10.24 s in the cell.

Finally, for the UE in the RRC_INACTIVE state, if the RAN eDRX cycle configured by the base station for the UE is greater than 10.24 s, the UE determines whether to monitor the paging using the configured RAN eDRX cycle based on the first indication information broadcast by the current serving cell.
a) If the first indication information indicates “true”, the UE monitors the paging using the configured RAN eDRX cycle.
b) Otherwise, the UE monitors the paging without using the configured RAN eDRX cycle. In this case, the behavior of the UE for monitoring the paging is the same as the behavior when the RAN eDRX is not configured.

FIG. 5 is a flowchart illustrating a method for a terminal device to monitor a paging according to an embodiment of the disclosure. As illustrated in FIG. 5, the method includes the following operations.

At operation S501, a base station configures an RAN eDRX cycle, and the RAN eDRX cycle is greater than 10.24 s.

The base station may configure the RAN eDRX cycle for UE.

At operation S502, the UE reads a system message from a current serving cell (corresponding to the first network device mentioned above), and obtains first indication information.

At operation S503, the UE determines whether the first indication information is true.

When the first indication information is true, operation S504 is executed, and when the first indication information is not true, operation S505 is executed.

At operation S504, the UE monitors a paging using the configured RAN eDRX cycle.

At operation S505, the UE monitors a paging without using the configured RAN eDRX cycle.

The configured RAN eDRX cycle may correspond to the first eDRX parameter or the first eDRX cycle in the embodiments mentioned above. The configured RAN eDRX cycle may be configured by the base station for the UE.

In some embodiments, when the RAN eDRX cycle configured by the base station for the UE is greater than 10.24 s, the UE determines whether to monitor the paging using the configured RAN eDRX cycle based on indication information, of “whether RRC_INACTIVE UE is allowed to use a (RAN) eDRX cycle exceeding 10.24 s”, broadcast by the current serving cell. When the indication information is “not allowed” and eDRX-Allowed-Inactive (corresponding to the second indication information mentioned above) indicates “allowed”, the UE falls back to using a default RAN eDRX cycle (corresponding to the second eDRX cycle mentioned above). The specific implementation process is as follows.

First of all, when releasing the UE to the RRC_INACTIVE state, the base station configures the RAN eDRX cycle for the UE through the RRC release message.

Secondly, the UE receives the system message broadcast by the serving cell. The system message includes indication information about the eDRX, and specifically may include first indication information and/or second indication information.

The first indication information indicates whether the UE in the RRC INACTTIVE state is allowed to use the (RAN) eDRX cycle exceeding 10.24 s in the cell.

The second indication information indicates whether the UE in the RRC INACTTIVE state is allowed to use the (RAN) eDRX in the cell or is allowed to use the (RAN) eDRX cycle not exceeding 10.24 s in the cell.

Finally, for the UE in the RRC_INACTIVE state, if the RAN eDRX cycle configured by the base station for the UE is greater than 10.24 s, the UE determines whether to monitor the paging using the configured RAN eDRX cycle based on the first indication information broadcast by the current serving cell.
a) If the first indication information indicates “true”, the UE monitors the paging using the configured RAN eDRX cycle.
b) Otherwise, if the second indication information indicates “true”, the UE monitors the paging using a default RAN eDRX cycle, and a value of the default RAN eDRX cycle does not exceed 10.24 s, which may be a value predefined by the standard (e.g., 10.24 s) or a value configured by the network.

c) Otherwise, the UE monitors the paging without using the RAN eDRX cycle. In this case, the behavior of the UE for monitoring the paging is the same as the case when the RAN eDRX is not configured.

For a fallback mechanism at operation b) in this embodiment, considering that some base stations do not support the fallback mechanism, one solution is that the anchor base station, before sending the paging message to other base stations (including the first network device) in the RAN paging area of the UE through an Xn interface, interacts configuration information through the Xn interface with a target base station (corresponding to the first network device mentioned above) to obtain whether the target base station supports the RAN eDRX cycle exceeding 10.24 s.

If the target base station does not support the RAN eDRX cycle exceeding 10.24 s, the RAN eDRX cycle carried in an RAN paging message sent by the anchor base station to the target base station is the default RAN eDRX cycle.

The target base station pages the UE using the default RAN eDRX cycle.

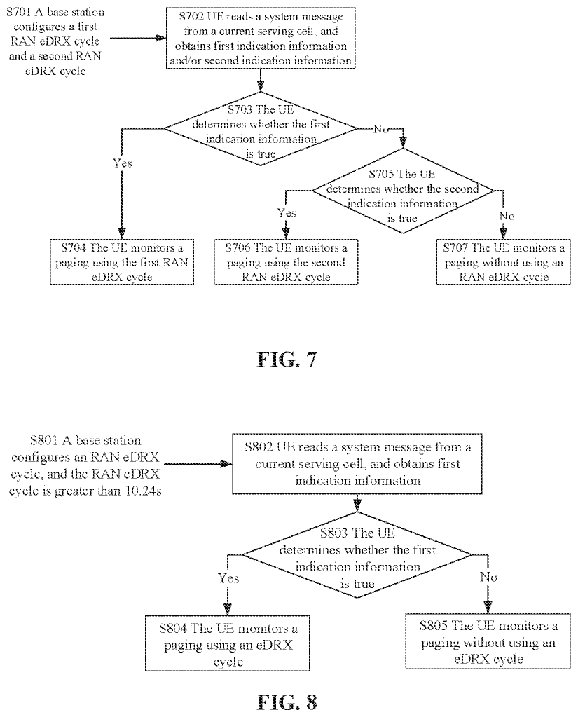

FIG. 6 is a flowchart illustrating another method for a terminal device to monitor a paging according to an embodiment of the disclosure. As illustrated in FIG. 6, the method includes the following operations.

At operation S601, a base station configures an RAN eDRX cycle, and the RAN eDRX cycle is greater than 10.24 s.

At operation S602, UE reads a system message from a current serving cell, and obtains first indication information and/or second indication information.

At operation S603, the UE determines whether the first indication information is true.

When the first indication information is true, operation S604 is executed, and when the first indication information is not true, operation S605 is executed.

At operation S604, the UE monitors a paging using the configured RAN eDRX cycle.

At operation S605, the UE determines whether the second indication information is true.

When the second indication information is true, operation S606 is executed, and when the second indication information is not true, operation S607 is executed.

At operation S606, the UE monitors the paging using a default RAN eDRX cycle.

At operation S607, the UE monitors the paging without using the RAN eDRX cycle.

In some embodiments, the base station may configure the first RAN eDRX cycle and the second RAN eDRX cycle for the UE. The first RAN eDRX cycle exceeds 10.24 s and the second RAN eDRX cycle does not exceed 10.24 s. The UE determines whether to monitor the paging using the configured first RAN eDRX cycle or the configured second RAN eDRX cycle based on indication information of “whether RRC_INACTIVE UE is allowed to use a (RAN) eDRX cycle exceeding 10.24 s” and/or indication information of “whether RRC_INACTIVE UE is allowed to use a (RAN) eDRX cycle not exceeding 10.24 s” broadcast by the current serving cell. The specific implementation process is as follows.

First of all, when releasing the UE to the RRC_INACTIVE state, the base station configures two RAN eDRX cycles for the UE through the RRC release message, i.e., the first RAN eDRX cycle and the second RAN eDRX cycle. The first RAN eDRX cycle is greater than 10.24 s and the second RAN eDRX cycle is less than or equal to 10.24 s.

Secondly, the UE receives the system message broadcast by the serving cell. The system message includes indication information about the eDRX, and specifically may include first indication information and/or second indication information.

The first indication information indicates whether the UE in the RRC INACTTIVE state is allowed to use the (RAN) eDRX cycle exceeding 10.24 s in the cell.

The second indication information indicates whether the UE in the RRC INACTTIVE state is allowed to use the (RAN) eDRX in the cell or is allowed to use the (RAN) eDRX cycle not exceeding 10.24 s in the cell.

Finally, for the UE in the RRC_INACTIVE state, if the base station configures the first RAN eDRX cycle and the second RAN eDRX cycle for the UE, the UE determines to monitor the paging using the configured first RAN eDRX cycle or the second RAN eDRX cycle or using other eDRX cycles and/or other DRX cycles other than the first RAN eDRX cycle and the second RAN eDRX cycle based on the first indication information and/or the second indication information broadcast by the current serving cell.
a) If the first indication information indicates “true”, the UE monitors the paging using the configured first RAN eDRX cycle.
b) Otherwise, if the second indication information indicates “true”, the UE monitors the paging using the configured second RAN eDRX cycle.
c) Otherwise, the UE monitors the paging without using the RAN eDRX cycle. In this case, the behavior of the UE for monitoring the paging is the same as the case when the RAN eDRX is not configured.

In order to implement the solutions in the embodiments of the disclosure, the first RAN eDRX parameter is added into the RAN paging message transmitted through the Xn interface. The specific implementation process is as follows. After receiving data for a certain UE from the core network, the anchor base station triggers the RAN paging and sends the RAN paging message to other base stations (including the first network device) in the RAN paging area of the UE through the Xn interface. The RAN paging message includes the first RAN eDRX parameter and a second RAN eDRX parameter of the UE. The first RAN eDRX parameter includes a PTW length and/or the first RAN eDRX cycle greater than 10.24 s. The second RAN eDRX parameter includes the second RAN eDRX cycle less than or equal to 10.24 s.

The base station (including the first network device) that receives the RAN paging message sets the first indication information and the second indication information for paging the UE based on the received RAN eDRX parameter, and/or the CN eDRX parameter received from the AMF, and/or the support status of the cell for the CN eDRX and the RAN eDRX. Optionally, the CN eDRX parameter may include the CN eDRX cycle in the embodiments mentioned above.

FIG. 7 is a flowchart illustrating yet another method for a terminal device to monitor a paging according to an embodiment of the disclosure. As illustrated in FIG. 7, the method includes the following operations.

At operation S701, a base station configures a first RAN eDRX cycle and a second RAN eDRX cycle.

At operation S702, UE reads a system message from a current serving cell, and obtains first indication information and/or second indication information.

At operation S703, the UE determines whether the first indication information is true.

When the first indication information is true, operation S704 is executed, and when the first indication information is not true, operation S705 is executed.

At operation S704, the UE monitors a paging using the first RAN eDRX cycle.

At operation S705, the UE determines whether the second indication information is true.

When the second indication information is true, operation S706 is executed, and when the second indication information is not true, operation S707 is executed.

At operation S706, the UE monitors the paging using the second RAN eDRX cycle.

At operation S707, the UE monitors the paging without using an RAN eDRX cycle.

In some embodiments, when the RAN eDRX cycle configured by the base station for the UE is greater than 10.24 s, the UE determines whether to monitor the paging using the eDRX based on indication information, of “whether RRC_INACTIVE UE configured with the RAN eDRX cycle greater than 10.24 s is allowed to use the eDRX”, broadcast by the current serving cell. When the indication information is “not allowed”, the UE monitors the paging without using the eDRX cycle. The specific implementation process is as follows.

First of all, when releasing the UE to the RRC_INACTIVE state, the base station configures the RAN eDRX cycle for the UE through the RRC release message.

Secondly, the UE in the INACTIVE state receives the system message broadcast by the serving cell. The system message includes indication information about the eDRX, and specifically may include first indication information and/or second indication information.

The first indication information indicates whether the UE in the RRC INACTTIVE state configured with the RAN eDRX cycle greater than 10.24 s is allowed to use the eDRX in the cell.

The second indication information indicates whether the UE in the RRC INACTTIVE state is allowed to use the eDRX in the cell.

Finally, for the UE in the RRC_INACTIVE state, if the RAN eDRX cycle configured by the base station for the UE is greater than 10.24 s, the UE determines whether to monitor the paging using the eDRX cycle based on the first indication information broadcast by the current serving cell.
a) If the first indication information indicates “true”, the UE monitors the paging using the eDRX.
b) Otherwise, the UE monitors the paging without using the eDRX. In this case, the behavior of the UE for monitoring the paging is the same as the case when the eDRX is not configured.

FIG. 8 is a flowchart illustrating still another method for a terminal device to monitor a paging according to an embodiment of the disclosure. As illustrated in FIG. 8, the method includes the following operations.

At operation S801, a base station configures an RAN eDRX cycle, and the RAN eDRX cycle is greater than 10.24 s.

At operation S802, UE reads a system message from a current serving cell, and obtains first indication information.

At operation S803, the UE determines whether the first indication information is true.

When the first indication information is true, operation S804 is executed, and when the first indication information is not true, operation S805 is executed.

At operation S804, the UE monitors a paging using an eDRX cycle.

At operation S805, the UE monitors a paging without using an eDRX cycle.

In some embodiments, when the RAN eDRX cycle configured by the base station for the UE is greater than 10.24 s, the UE determines whether to monitor the paging using the configured RAN eDRX cycle based on indication information of “whether RRC_INACTIVE UE configured with the RAN eDRX cycle greater than 10.24 s is allowed to use the eDRX” broadcast by the current serving cell. When the indication information is “not allowed” and eDRX-Allowed-Inactive (corresponding to the second indication information mentioned above) indicates “allowed”, the UE falls back to use a default RAN eDRX cycle. The specific implementation process is as follows.

First of all, when releasing the UE to the RRC_INACTIVE state, the base station configures the RAN eDRX cycle for the UE through the RRC release message.

Secondly, the UE receives the system message broadcast by the serving cell. The system message includes indication information about the eDRX, and specifically may include first indication information and/or second indication information.

The first indication information indicates whether the UE in the RRC INACTTIVE state configured with the RAN eDRX cycle greater than 10.24 s is allowed to use the eDRX in the cell.

The second indication information indicates whether the UE in the RRC INACTTIVE state is allowed to use the eDRX in the cell.

Finally, for the UE in the RRC_INACTIVE state, if the RAN eDRX cycle configured by the base station for the UE is greater than 10.24 s, the UE determines whether to monitor the paging using the eDRX configuration based on the first indication information broadcast by the current serving cell.
a) If the first indication information indicates “true”, the UE monitors the paging using the eDRX configuration.
b) Otherwise, if the second indication information indicates “true”, the UE monitors the paging based on the CN eDRX configuration and a default RAN eDRX cycle, and a value of the default RAN eDRX cycle does not exceed 10.24 s, which may be a value predefined by the standard (e.g., 10.24 s) or a value configured by the network.
c) Otherwise, the UE monitors the paging without using the eDRX. In this case, the behavior of the UE for monitoring the paging is the same as the case when the eDRX is not configured.

For a fallback mechanism at the above operation b) in this embodiment, considering that some base stations do not support the fallback mechanism, one solution is that the anchor base station, before sending the paging message to other base stations (including the first network device mentioned above) in the RAN paging area of the UE through an Xn interface, interacts configuration information through the Xn interface with a target base station (corresponding to the first network device mentioned above) to obtain whether the target base station supports the RAN eDRX cycle exceeding 10.24 s.

If the target base station does not support the RAN eDRX cycle exceeding 10.24 s, the RAN eDRX cycle carried in an RAN paging message sent by the anchor base station to the target base station is the default RAN eDRX cycle.

The target base station pages the UE using the default RAN eDRX cycle.

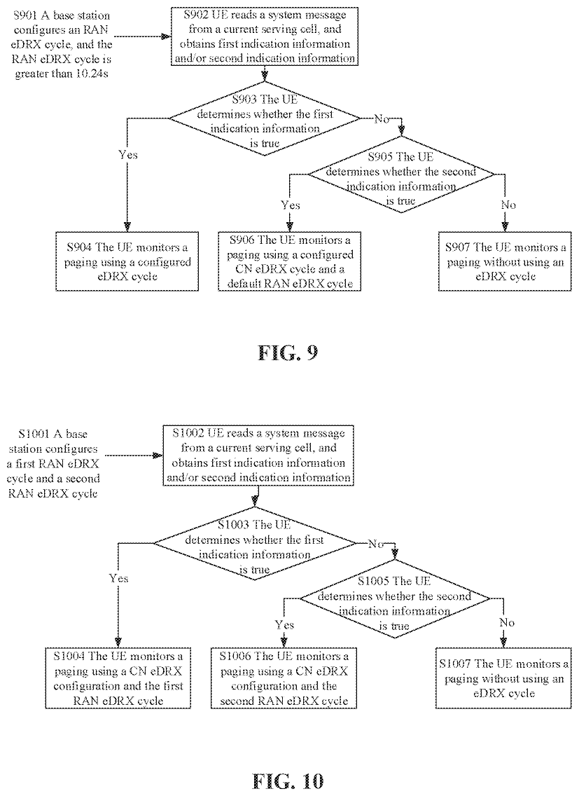

FIG. 9 is a flowchart illustrating a method for a terminal device to monitor a paging according to another embodiment of the disclosure. As illustrated in FIG. 9, the method includes the following operations.

At operation S901, a base station configures an RAN eDRX cycle, and the RAN eDRX cycle is greater than 10.24 s.

At operation S902, UE reads a system message from a current serving cell, and obtains first indication information and/or second indication information.

At operation S903, the UE determines whether the first indication information is true.

When the first indication information is true, operation S904 is executed, and when the first indication information is not true, operation S905 is executed.

At operation S904, the UE monitors a paging using a configured eDRX cycle.

At operation S905, the UE determines whether the second indication information is true.

When the second indication information is true, operation S906 is executed, and when the second indication information is not true, operation S907 is executed.

At operation S906, the UE monitors a paging using a configured CN eDRX cycle and a default RAN eDRX cycle.

At operation S907, the UE monitors a paging without using an eDRX.

In some embodiments, the base station may configure the first RAN eDRX cycle and the second RAN eDRX cycle for the UE. The first RAN eDRX cycle exceeds 10.24 s and the second RAN eDRX cycle does not exceed 10.24 s. The UE determines whether to monitor the paging using the configured first RAN eDRX cycle or the configured second RAN eDRX cycle based on indication information of “whether RRC_INACTIVE UE configured with the RAN eDRX cycle greater than 10.24 s is allowed to use the eDRX” and/or indication information of “whether RRC_INACTIVE UE is allowed to use the eDRX” broadcast by the current serving cell. The specific implementation process is as follows.

First of all, when releasing the UE to the RRC_INACTIVE state, the base station configures two RAN eDRX cycles for the UE through the RRC release message, i.e., the first RAN eDRX cycle and the second RAN eDRX cycle. The first RAN eDRX cycle is greater than 10.24 s and the second RAN eDRX cycle is less than or equal to 10.24 s.

Secondly, the UE receives the system message broadcast by the serving cell. The system message includes indication information about the eDRX, and specifically may include first indication information and/or second indication information.

The first indication information indicates whether the UE in the RRC INACTTIVE state configured with the RAN eDRX cycle greater than 10.24 s is allowed to use the eDRX in the cell.

The second indication information indicates whether the UE in the RRC INACTTIVE state is allowed to use the eDRX in the cell.

Finally, for the UE in the RRC_INACTIVE state, if the base station configures the first RAN eDRX cycle and the second RAN eDRX cycle for the UE, the UE determines whether to monitor the paging using the configured first RAN eDRX cycle or the configured second RAN eDRX cycle based on the first indication information and the second indication information broadcast by the current serving cell.
a) If the first indication information indicates “true”, the UE monitors the paging using the configured first RAN eDRX cycle.
b) Otherwise, if the second indication information indicates “true”, the UE monitors the paging using the configured second RAN eDRX cycle.
c) Otherwise, the UE monitors the paging without using the RAN eDRX cycle. In this case, the behavior of the UE for monitoring the paging is the same as the case when the eDRX is not configured.

In order to implement the solutions in the embodiments of the disclosure, the first RAN eDRX parameter is added into the RAN paging message transmitted through the Xn interface. The specific implementation process is as follows.

After receiving data for a certain UE from the core network, the anchor base station triggers the RAN paging and sends the RAN paging message to other base stations (including the first network device) in the RAN paging area of the UE through the Xn interface. The RAN paging message includes the first RAN eDRX parameter and a second RAN eDRX parameter of the UE. The first RAN eDRX parameter includes a PTW length and/or the first RAN eDRX cycle greater than 10.24 s. The second RAN eDRX parameter includes the second RAN eDRX cycle less than or equal to 10.24 s.

The base station (including the first network device) that receives the RAN paging message sets the first indication information and the second indication information for paging the UE based on the received RAN eDRX parameter, and/or the CN eDRX parameter received from the AMF, and/or the support status of the cell for the CN eDRX and the RAN eDRX.

FIG. 10 is a flowchart illustrating a method for a terminal device to monitor a paging according to yet another embodiment of the disclosure. As illustrated in FIG. 10, the method includes the following operations.

At operation S1001, a base station configures a first RAN eDRX cycle and a second RAN eDRX cycle.

At operation S1002, UE reads a system message from a current serving cell, and obtains first indication information and/or second indication information.

At operation S1003, the UE determines whether the first indication information is true.

When the first indication information is true, operation S1004 is executed, and when the first indication information is not true, operation S1005 is executed.

At operation S1004, the UE monitors a paging using a CN eDRX configuration and the first RAN eDRX cycle.

At operation S1005, the UE determines whether the second indication information is true.

When the second indication information is true, operation S1006 is executed, and when the second indication information is not true, operation S1007 is executed.

At operation S1006, the UE monitors a paging using a CN eDRX configuration and the second RAN eDRX cycle.

At operation S1007, the UE monitors a paging without using an eDRX cycle.

The embodiments of the disclosure provide a method of using the eDRX for the UE in the RRC_INACTIVE state. The indication information is introduced into the system message, which indicates whether the RRC_INACTIVE UE supports the (RAN) eDRX exceeding 10.24 s. When the support for the eDRX function in the RRC_INACTIVE state varies among different base stations, the RRC_INACTIVE UE can monitor the paging based on the support for the eDRX function in the RRC_INACTIVE state indicated by the current serving cell after moving to another cell, which can effectively prevent the terminal from missing the paging and also take into account the energy saving of the terminal.

In some optional embodiments, the operation that the terminal device monitors the paging using the first eDRX parameter and/or the second eDRX parameter includes that: the terminal device monitors the paging based on the PF and PO in the first eDRX cycle and/or the PF and PO in the second eDRX cycle. Optionally, the method for determining the PF and PO in the first eDRX cycle and/or the method for determining the PF and PO in the second eDRX cycle may be similar to the method for determining the PF and PO in a paging DRX cycle, except that T represents the first eDRX cycle and/or the second eDRX cycle in which the UE receives the paging, or T represents the PTW and/or the second eDRX cycle in which the UE receives the paging.

The preferred embodiments of the disclosure have been described in detail with reference to the drawings, but the disclosure is not limited to the specific details in the above embodiments. Various simple modifications can be made to the technical solutions of the disclosure within the scope of the technical conception of the disclosure, all of which fall within the scope of protection of the disclosure. For example, the specific technical features described in the above specific embodiments/implementations may be combined in any suitable manner without conflict with each other, and various possible combinations are not further described in the disclosure in order to avoid unnecessary repetition. For another example, different embodiments/implementations of the disclosure can be combined arbitrarily, and the combined embodiments/implementations should also be regarded as the contents disclosed in the disclosure as long as they do not violate the idea of the disclosure. For another example, the embodiments/implementations and/or features in the embodiments/implementations described in the disclosure may be arbitrarily combined with the related art without conflict, and the solutions obtained through any combination should fall within the scope of protection of the disclosure.

It should be understood that the magnitude of serial numbers of the foregoing processes/operations do not mean execution sequences in various method embodiments of the disclosure. The execution sequences of the processes should be determined according to functions and internal logics of the processes, and should not be construed as any limitation to the implementation processes of the embodiments of disclosure. In addition, in the embodiments of the disclosure, the terms “downlink”, “uplink” and “sidelink” indicate a transmission direction of the signal or data. The term “downlink” indicates that the transmission direction of the signal or data is a first direction from a station to UE in a cell, the term “uplink” indicates that the transmission direction of the signal or data is a second direction from the UE in the cell to the station, and the term “sidelink” indicates that the transmission direction of the signal or data is a third direction from a first user equipment to a second user equipment. For example, a “downlink signal” means that the transmission direction of the signal is the first direction. In addition, in the embodiments of the disclosure, the term “and/or” is only an association relationship describing associated objects and represents that there are three relationships. Specifically, A and/or B may represent three situations: independent existence of A, existence of both A and B and independent existence of B. In addition, the character “/” used herein usually represents that the associated objects before and after the character form an “or” relationship.

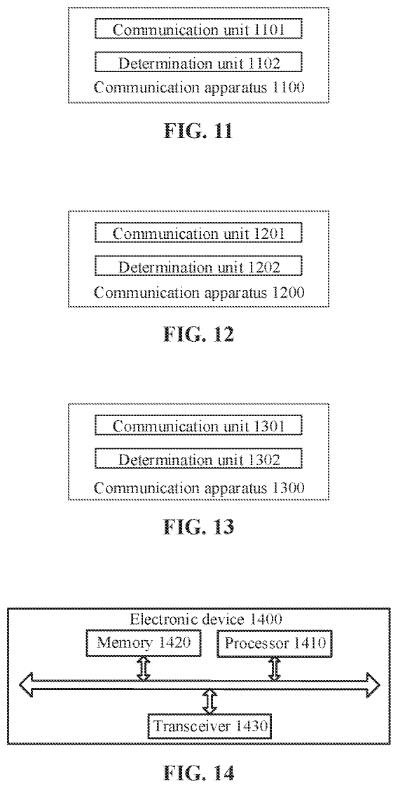

FIG. 11 is a schematic diagram illustrating a structural composition of a communication apparatus according to an embodiment of the disclosure, which is applied to a terminal device. As illustrated in FIG. 11, the communication apparatus 1100 includes: a communication unit 1101 and a determination unit 1102. The communication unit 1101 is configured to receive first information from a first network device. The determination unit 1102 is configured to determine, based on the first information, whether to monitor a paging using a first eDRX parameter. The first eDRX parameter includes a first eDRX cycle and/or a PTW, and the first eDRX cycle is greater than a predefined cycle.

In some embodiments, the first eDRX parameter is configured by a second network device for the terminal device, or the first eDRX parameter is determined based on a pre-configuration.

In some embodiments, the communication unit 1101 is further configured to receive an RRC release message from the second network device. The RRC release message carries the first eDRX parameter.

In some embodiments, the terminal device monitors the paging without using the first eDRX parameter, which includes one of the following operations. The terminal device monitors the paging without using an RAN eDRX cycle. The terminal device monitors the paging without using an eDRX cycle. The terminal device monitors the paging using a second eDRX parameter. The terminal device monitors the paging without using the first eDRX parameter and the second eDRX parameter. The terminal device monitors the paging using a predefined eDRX cycle. Herein, the second eDRX parameter includes a second eDRX cycle, and the second eDRX cycle is less than or equal to the predefined cycle.

In some embodiments, the operation that the terminal device monitors the paging without using the first eDRX parameter includes that: the terminal device monitors the paging using a CN eDRX cycle and/or a DRX cycle.

In some embodiments, the operation that the terminal device monitors the paging without using the RAN eDRX cycle, or the operation that the terminal device monitors the paging without using the first eDRX parameter and the second eDRX parameter includes that: the terminal device monitors the paging using a CN eDRX cycle and/or a DRX cycle; and/or the operation that the terminal device monitors the paging without using the eDRX cycle includes that: the terminal device monitors the paging using the DRX cycle.

In some embodiments, the first information indicates that the terminal device is allowed to monitor the paging using an RAN eDRX cycle greater than the predefined cycle. Alternatively, the first information indicates that the terminal device is not allowed to monitor the paging using the RAN eDRX cycle greater than the predefined cycle.

In some embodiments, the determination unit 1102 is further configured to monitor the paging using the first eDRX parameter when the terminal device is configured with the first eDRX parameter, and the first information indicates that the terminal device is allowed to monitor the paging using an RAN eDRX cycle greater than the predefined cycle.

In some embodiments, the determination unit 1102 is further configured to monitor the paging without using the first eDRX parameter when the terminal device is configured with the first eDRX parameter, and the first information indicates that the terminal device is not allowed to monitor the paging using an RAN eDRX cycle greater than the predefined cycle.

In some embodiments, the communication unit 1101 is further configured to receive second information from the first network device.

The determination unit 1102 is further configured to monitor the paging using a second eDRX parameter when the terminal device is configured with the first eDRX parameter, the first information indicates that the terminal device is not allowed to monitor the paging using the RAN eDRX cycle greater than the predefined cycle, and when the second information indicates that: the terminal device is allowed to monitor the paging using an RAN eDRX or the terminal device is allowed to monitor the paging using an RAN eDRX cycle less than or equal to the predefined cycle. The second eDRX parameter includes a second eDRX cycle, and the second eDRX cycle is less than or equal to the predefined cycle.

In some embodiments, the communication unit 1101 is further configured to receive second information from the first network device.

The determination unit 1102 is further configured to: monitor the paging without using an RAN eDRX cycle, or monitor the paging without using the first eDRX parameter and a second eDRX parameter when the terminal device is configured with the first eDRX parameter, the first information indicates that the terminal device is not allowed to monitor the paging using the RAN eDRX cycle greater than the predefined cycle, and when the second information indicates that: the terminal device is not allowed to monitor the paging using an RAN eDRX or the terminal device is not allowed to monitor the paging using an RAN eDRX cycle less than or equal to the predefined cycle. The second eDRX parameter includes a second eDRX cycle, and the second eDRX cycle is less than or equal to the predefined cycle.

In some embodiments, the first information indicates that a terminal device configured with the first eDRX cycle greater than the predefined cycle is allowed to monitor the paging using an eDRX. Alternatively, the first information indicates that a terminal device configured with the first eDRX cycle greater than the predefined cycle is not allowed to monitor the paging using the eDRX.

In some embodiments, the determination unit 1102 is further configured to monitor the paging using the first eDRX parameter when the terminal device is configured with the first eDRX parameter, and the first information indicates that the terminal device configured with the first eDRX cycle greater than the predefined cycle is allowed to monitor the paging using an eDRX.

In some embodiments, the determination unit 1102 is further configured to monitor the paging without using the first eDRX parameter when the terminal device is configured with the first eDRX parameter, and the first information indicates that the terminal device configured with the first eDRX cycle greater than the predefined cycle is not allowed to monitor the paging using an eDRX.

In some embodiments, the communication unit 1101 is further configured to receive second information from the first network device.

The determination unit 1102 is further configured to monitor the paging using a second eDRX parameter and/or a CN eDRX cycle when the terminal device is configured with the first eDRX parameter, the first information indicates that the terminal device configured with the first eDRX cycle greater than the predefined cycle is not allowed to monitor the paging using the eDRX, and when the second information indicates that the terminal device is allowed to monitor the paging using the eDRX. The second eDRX parameter includes a second RAN eDRX cycle, and the second RAN eDRX cycle is less than or equal to the predefined cycle.

In some embodiments, the communication unit 1101 is further configured to receive second information from the first network device.

The determination unit 1102 is further configured to monitor the paging without using an eDRX cycle when the terminal device is configured with the first eDRX parameter, the first information indicates that the terminal device configured with the first eDRX cycle greater than the predefined cycle is not allowed to monitor the paging using the eDRX, and when the second information indicates that the terminal device is not allowed to monitor the paging using the eDRX.

In some embodiments, the second eDRX parameter is predefined by a protocol; or the second eDRX parameter is determined by the terminal device based on a pre-configuration; or the second eDRX parameter is sent by the first network device.

In some embodiments, the second eDRX parameter is sent to the terminal device from a second network device.

In some embodiments, the communication unit 1101 is further configured to receive an RRC release message from a second network device. The RRC release message carries the second eDRX parameter.

In some embodiments, the terminal device is in an inactive state.

FIG. 12 is a schematic diagram illustrating a structural composition of another communication apparatus according to an embodiment of the disclosure, which is applied to a first network device. As illustrated in FIG. 12, the communication apparatus 1200 includes: a communication unit 1201 and a determination unit 1202. The communication unit 1201 is configured to send first information to a terminal device. The determination unit 1202 is configured to determine, based on the first information, whether to send a paging using a first eDRX parameter. The first eDRX parameter includes a first eDRX cycle and/or a PTW, and the first eDRX cycle is greater than a predefined cycle.

In some embodiments, the first eDRX parameter is sent to the first network device from a second network device, and/or the first eDRX parameter is determined by the first network device based on a pre-configuration.

In some embodiments, the communication unit 1201 is further configured to receive a paging carrying the first eDRX parameter from a second network device.

In some embodiments, the communication unit 1201 is further configured to receive the paging carrying the first eDRX parameter from the second network device when the first information sent to the second network device from the first network device indicates that the terminal device is allowed to monitor the paging using an RAN eDRX cycle greater than the predefined cycle, or indicates that a terminal device configured with the first eDRX cycle greater than the predefined cycle is allowed to monitor the paging using an eDRX.

In some embodiments, the first network device sends the paging without using the first eDRX parameter, which includes one of the following operations. The first network device sends the paging without using an RAN eDRX cycle. The first network device sends the paging without using an eDRX cycle. The first network device sends the paging using a second eDRX parameter. The first network device sends the paging without using the first eDRX parameter and the second eDRX parameter. The first network device sends the paging using a predefined eDRX cycle. The second eDRX parameter includes a second eDRX cycle, and the second eDRX cycle is less than or equal to the predefined cycle.

In some embodiments, the operation that the first network device sends the paging without using the first eDRX parameter includes that: the first network device sends the paging using a CN eDRX cycle and/or a DRX cycle.

In some embodiments, the operation that the first network device sends the paging without using the RAN eDRX cycle, or the operation that the first network device sends the paging without using the first eDRX parameter and the second eDRX parameter includes that: the first network device sends the paging using a CN eDRX cycle and/or a DRX cycle; and/or the operation that the first network device sends the paging without using the eDRX cycle includes that: the first network device sends the paging using the DRX cycle.

In some embodiments, the first information indicates that the terminal device is allowed to monitor the paging using an RAN eDRX cycle greater than the predefined cycle. Alternatively, the first information indicates that the terminal device is not allowed to monitor the paging using the RAN eDRX cycle greater than the predefined cycle.

In some embodiments, the determination unit 1202 is further configured to send the paging using the first eDRX parameter when a second network device configures the first eDRX parameter for the first network device, and the first information indicates that the terminal device is allowed to monitor the paging using an RAN eDRX cycle greater than the predefined cycle.

In some embodiments, the determination unit 1202 is further configured to send the paging without using the first eDRX parameter when a second network device configures the first eDRX parameter for the first network device, and the first information indicates that the terminal device is not allowed to monitor the paging using an RAN eDRX cycle greater than the predefined cycle.

In some embodiments, the communication unit 1201 is further configured to send second information to the terminal device.

The determination unit 1202 is further configured to send the paging using a second eDRX parameter when the second network device configures the first eDRX parameter for the first network device, the first information indicates that the terminal device is not allowed to monitor the paging using the RAN eDRX cycle greater than the predefined cycle, and when the second information indicates that: the terminal device is allowed to monitor the paging using an RAN eDRX or the terminal device is allowed to monitor the paging using an RAN eDRX cycle less than or equal to the predefined cycle. The second eDRX parameter includes a second eDRX cycle, and the second eDRX cycle is less than or equal to the predefined cycle.

In some embodiments, the communication unit 1201 is further configured to send second information to the terminal device.

The determination unit 1202 is further configured to send the paging without using an RAN eDRX cycle or send the paging without using the first eDRX parameter and a second eDRX parameter when the second network device configures the first eDRX parameter for the first network device, the first information indicates that the terminal device is not allowed to monitor the paging using the RAN eDRX cycle greater than the predefined cycle, and when the second information indicates that: the terminal device is not allowed to monitor the paging using an RAN eDRX or the terminal device is not allowed to monitor the paging using an RAN eDRX cycle less than or equal to the predefined cycle. The second eDRX parameter includes a second eDRX cycle, and the second eDRX cycle is less than or equal to the predefined cycle.

In some embodiments, the first information indicates that a terminal device configured with the first eDRX cycle greater than the predefined cycle is allowed to monitor the paging using an eDRX. Alternatively, the first information indicates that a terminal device configured with the first eDRX cycle greater than the predefined cycle is not allowed to monitor the paging using the eDRX.

In some embodiments, the determination unit 1202 is further configured to send the paging using the first eDRX parameter when a second network device configures the first eDRX parameter for the first network device, and the first information indicates that the terminal device configured with the first eDRX cycle greater than the predefined cycle is allowed to monitor the paging using the eDRX.

In some embodiments, the determination unit 1202 is further configured to send the paging without using the first eDRX parameter when the second network device configures the first eDRX parameter for the first network device, and the first information indicates that the terminal device configured with the first eDRX cycle greater than the predefined cycle is not allowed to monitor the paging using the eDRX.

In some embodiments, the communication unit 1201 is further configured to send second information to the terminal device.

The determination unit 1202 is further configured to send the paging using a second eDRX parameter and/or a CN eDRX cycle when the second network device configures the first eDRX parameter for the first network device, the first information indicates that the terminal device configured with the first eDRX cycle greater than the predefined cycle is not allowed to monitor the paging using the eDRX, and when the second information indicates that the terminal device is allowed to monitor the paging using the eDRX. The second eDRX parameter includes a second eDRX cycle, and the second eDRX cycle is less than or equal to the predefined cycle.

In some embodiments, the communication unit 1201 is further configured to send second information to the terminal device.

The determination unit 1202 is further configured to send the paging without using an eDRX cycle when the second network device configures the first eDRX parameter for the first network device, the first information indicates that the terminal device configured with the first eDRX cycle greater than the predefined cycle is not allowed to monitor the paging using the eDRX, and when the second information indicates that the terminal device is not allowed to monitor the paging using the eDRX.

In some embodiments, the second eDRX parameter is predefined by a protocol; or the second eDRX parameter is determined by the first network device based on a pre-configuration.

In some embodiments, the second eDRX parameter is sent to the first network device from a second network device.

In some embodiments, the communication unit 1201 is further configured to receive, from a second network device, a paging carrying the first eDRX parameter and the second eDRX parameter, or a paging carrying the second eDRX parameter.

In some embodiments, the communication unit 1201 is further configured to receive, from the second network device, the paging carrying the first eDRX parameter and the second eDRX parameter or the paging carrying the second eDRX parameter when the first information sent to the second network device from the first network device indicates that the terminal device is not allowed to monitor the paging using the RAN eDRX cycle greater than the predefined cycle or indicates that the terminal device configured with the first eDRX cycle greater than the predefined cycle is not allowed to monitor the paging using eDRX.

FIG. 13 is a schematic diagram illustrating a structural composition of yet another communication apparatus according to an embodiment of the disclosure, which is applied to a second network device. As illustrated in FIG. 13, the communication apparatus 1300 includes a communication unit 1301. The communication unit 1301 is configured to send a paging carrying a first eDRX parameter to a first network device. The first eDRX parameter includes a first eDRX cycle and/or a PTW, and the first eDRX cycle is greater than a predefined cycle.

In some embodiments, the communication apparatus 1300 further includes a determination unit 1302 configured to determine the paging carrying the first eDRX parameter.

In some embodiments, the first eDRX cycle is a first RAN eDRX cycle.

In some embodiments, the communication unit 1301 is further configured to send the paging carrying the first eDRX parameter to the first network device when first information received by the second network device from the first network device indicates that a terminal device is allowed to monitor a paging using an RAN eDRX cycle greater than the predefined cycle, or indicates that a terminal device configured with the first eDRX cycle greater than the predefined cycle is allowed to monitor the paging using an eDRX.

In some embodiments, the communication unit 1301 is further configured to send, to the first network device, a paging carrying a second eDRX parameter or a paging carrying the first eDRX parameter and the second eDRX parameter. The second eDRX parameter includes a second eDRX cycle, and the second eDRX cycle is less than or equal to the predefined cycle.

In some embodiments, the communication unit 1301 is further configured to send, to the first network device, the paging carrying the second eDRX parameter or the paging carrying the first eDRX parameter and the second eDRX parameter when first information received by the second network device from the first network device indicates that a terminal device is not allowed to monitor a paging using an RAN eDRX cycle greater than the predefined cycle or indicates that a terminal device configured with the first eDRX cycle greater than the predefined cycle is not allowed to monitor the paging using an eDRX.

In some embodiments, the determination unit 1302 is further configured to determine the paging carrying the second eDRX parameter, or the paging carrying the first eDRX parameter and the second eDRX parameter.

In some embodiments, the communication unit 1301 is further configured to: configure the first eDRX parameter and/or a second eDRX parameter for a terminal device. The first eDRX parameter and/or the second eDRX parameter are used for the terminal device to monitor a paging. The second eDRX parameter includes a second eDRX cycle, and the second eDRX cycle is less than or equal to the predefined cycle.

In some embodiments, the communication unit 1301 is further configured to send an RRC release message to the terminal device. The RRC release message carries the first eDRX parameter and/or the second eDRX parameter.

It should be understood by those skilled in the art that the descriptions about the communication apparatuses in the embodiments of the disclosure may be understood with reference to the descriptions about the communication methods in the embodiments of the disclosure.

FIG. 14 is a schematic structural diagram of an electronic device according to an embodiment of the disclosure. The electronic device 1400 illustrated in FIG. 14 may include a processor 1410 and a memory 1420. The memory 1420 is configured to store a computer program executable on the processor 1410. The processor 1410 is configured to implement the method the communication method in any of the above embodiments when executing the program. Optionally, the memory 1420 may be a separate device independent of the processor 1410 or may be integrated into the processor 1410.

In some embodiments, as illustrated in FIG. 14, the electronic device 1400 may further include a transceiver 1430, and the processor 1410 may control the transceiver 1430 to communicate with other devices. Specifically, the transceiver 1430 sends information or data to the other devices or receives information or data from the other devices. The transceiver 1430 may include a transmitter and a receiver. The transceiver 1430 may further include an antenna. The number of the antennas may be one or more.

In some embodiments, the electronic device 1400 may specifically be a terminal device, a first network device, or a second network device in the embodiments of the disclosure, and the electronic device 1400 may implement corresponding processes implemented by the terminal device, the first network device, or the second network device in each method of the embodiments of the disclosure. For simplicity, elaborations are omitted herein.

An embodiment of the disclosure further provides a computer storage medium having stored thereon one or more programs that, when executed by one or more processors, cause the one or more processors to implement the communication method in any embodiment of the disclosure.

In some embodiments, the computer-readable storage medium may be applied to the terminal device, the first network device, or the second network device in the embodiments of the disclosure, and the computer program causes the computer to execute corresponding processes implemented by the terminal device, the first network device, or the second network device in each method of the embodiments of the disclosure. For simplicity, elaborations are omitted herein.

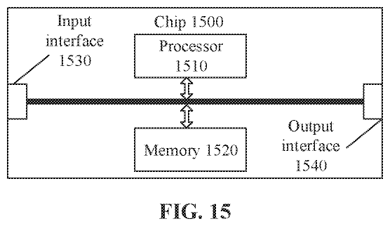

FIG. 15 is a schematic structural diagram of a chip according to an embodiment of the disclosure. The chip 1500 illustrated in FIG. 15 includes a processor 1510, and the processor 1510 is configured to call a computer program from a memory and run the computer program, to perform the method in any embodiment of the disclosure.

In some embodiments, as illustrated in FIG. 15, the chip 1500 may further include a memory 1520. The processor 1510 can call the computer program from the memory 1520 and run the computer program to implement the methods in the embodiments of the disclosure.

The memory 1520 may be a separate device independent of the processor 1510 or may be integrated into the processor 1510.

In some embodiments, the chip 1500 may further include an input interface 1530. The processor 1510 may control the input interface 1530 to communicate with other devices or chips. Specifically, the input interface may acquire information or data from the other devices or chips.

In some embodiments, the chip 1500 may further include an output interface 1540. The processor 1510 may control the output interface 1540 to communicate with other devices or chips. Specifically, the output interface may output information or data to the other devices or chips.

In some embodiments, the chip can be applied to the terminal device, the first network device, or the second network device in the embodiments of the disclosure, and the chip can implement corresponding processes implemented by the terminal device, the first network device, or the second network device in each method of the embodiments of the disclosure. For simplicity, elaborations are omitted herein. It is to be understood that the chip mentioned in the embodiments of the disclosure may also be called a system-level chip, a system chip, a chip system or a system on chip, or the like.

An embodiment of the disclosure further provides a computer program product, which includes a computer storage medium. The computer storage medium has stored thereon a computer program including instructions executable by at least one processor. When the instructions are executed by the at least one processor, the processor is caused to implement the communication method in any embodiment of the disclosure.

In some embodiments, the computer program product can be applied to the terminal device, the first network device, or the second network device in the embodiments of the disclosure, and the computer program instructions cause the computer to execute corresponding processes implemented by the terminal device, the first network device, or the second network device in each method of the embodiments of the disclosure. For simplicity, elaborations are omitted herein.

Optionally, the computer program product in the embodiment of the disclosure may also be referred to as a software product in other embodiments.

An embodiment of the disclosure further provides a computer program causing a computer to perform the communication method in any embodiment of the disclosure. In some embodiments, the computer program can be applied to the terminal device, the first network device, or the second network device in the embodiments of the disclosure, and when the computer program is run on the computer, the computer executes the corresponding process implemented by the terminal device, the first network device, or the second network device in each method of the embodiments of the disclosure. For simplicity, elaborations are omitted herein.

The processor, the communication apparatus or the chip in the embodiments of the disclosure may be an integrated circuit chip and has a signal processing capability. In an implementation process, each operation in the method embodiments may be completed by an integrated logical circuit in a hardware form in the processor or instructions in a software form. The above processor, the communication apparatus or the chip may include an integration of one or more of the followings: a general purpose processor, an Application Specific Integrated Circuit (ASIC), a Digital Signal Processor (DSP), a Digital Signal Processing Device (DSPD), a Programmable Logic Device (PLD), a Field Programmable Gate Array (FPGA), a Central Processing Unit (CPU), a Graphic Processing Unit (GPU), an embedded Neural-network Processing Unit (NPU), a controller, a microcontroller, a microprocessor, a programmable logical device, a discrete gate or transistor logical device, or a discrete hardware component, for implementing or executing each method, step and logical block diagram disclosed in the embodiments of the disclosure. The general purpose processor may be a microprocessor or the processor may also be any conventional processor and the like. The steps in the methods disclosed in combination with the embodiments of the disclosure may be directly embodied to be executed and completed by a hardware decoding processor or executed and completed by a combination of hardware in the decoding processor and software modules. The software module may be located in a mature storage medium in this field such as a Random Access Memory (RAM), a flash memory, a Read-Only Memory (ROM), a Programmable ROM (PROM), an Electrically Erasable PROM (EEPROM) and a register. The storage medium is located in a memory, and the processor reads information in the memory, and completes the steps in the above methods in combination with the hardware of the processor.

It can be understood that the memory or the computer storage medium in the embodiments of the disclosure may be a volatile memory or a non-volatile memory, or may include both the volatile and the non-volatile memories. The non-volatile memory may be a ROM, a PROM, an Erasable PROM (EPROM), an EEPROM or a flash memory. The volatile memory may be a RAM, and is used as an external cache. By way of illustrative but not limiting description, RAMs in various forms may be adopted, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a Synch link DRAM (SLDRAM) and a Direct Rambus RAM (DR RAM). It is to be noted that the memory for the system and method described in the disclosure is intended to include, but not limited to, these and any other suitable types of memories.

It is to be understood that the above description of the memory or the computer storage medium is exemplary and non-limiting. For example, the memory in the embodiments of the disclosure may also be an SRAM, a DRAM, an SDRAM, a DDR SDRAM, an ESDRAM, an SLDRAM, a DR RAM and the like. That is, the memory in the embodiments of the disclosure is intended to include, but not limited to, these and any other suitable types of memories.

Those of ordinary skill in the art may realize that the units and algorithm steps of each example described in combination with the embodiments disclosed in the disclosure may be implemented by electronic hardware or a combination of computer software and the electronic hardware. Whether these functions are executed in a hardware or software manner depends on specific applications and design constraints of the technical solutions. Professionals may implement the described functions for each specific application by use of different methods, but such implementation shall fall within the scope of the disclosure.

Those skilled in the art may clearly learn about that specific working processes of the system, device and unit described above may refer to the corresponding processes in the method embodiments and will not be elaborated herein for convenient and brief description.

In some embodiments provided by the disclosure, it is to be understood that the disclosed system, device and method may be implemented in another manner. For example, the device embodiment described above is only schematic, and for example, division of the units is only a logic function division, and other division manners may be adopted during practical implementation. For example, multiple units or components may be combined or integrated into another system, or some characteristics may be neglected or not executed. In addition, coupling or direct coupling or communication connection between displayed or discussed components may be indirect coupling or communication connection through some interfaces, devices or units, and may be electrical, mechanical or in other forms.

The units described as separate parts may or may not be physically separated, and parts displayed as units may or may not be physical units, and namely may be located in the same place, or may also be distributed onto multiple network units. Part or all of the units may be selected to achieve the purpose of the solutions in the embodiments according to a practical requirement.

In addition, functional units in each embodiment of the disclosure may be integrated into a processing unit, each unit may also exist physically and independently, or two or more than two units may also be integrated into a unit.

When being realized in form of software functional unit and sold or used as an independent product, the function may also be stored in a computer-readable storage medium. Based on such an understanding, the technical solutions of the disclosure substantially or parts making contributions to the conventional art or part of the technical solutions may be embodied in form of software product, and the computer software product is stored in a storage medium, including a plurality of instructions configured to enable a computer device (which may be a personal computer, a server, a network device or the like) to execute all or part of the steps of the method in each embodiment of the disclosure. The abovementioned storage medium includes: various media capable of storing program codes such as a U disk, a mobile hard disk, a ROM, a RAM, a magnetic disk or an optical disk.

Described above are merely specific embodiments of the disclosure and the scope of protection of the disclosure is not limited thereto. Any variation or replacement easily conceivable by those skilled in the art within the technical scope disclosed by the disclosure shall fall within the scope of protection of the disclosure. Therefore, the scope of protection of the disclosure shall be subject to the scope of protection of the claims.

1. A communication method, comprising:
receiving, by a terminal device, first information from a first network device; and
determining, by the terminal device, whether to monitor a paging using a first Extended Discontinuous Reception (eDRX) parameter based on the first information,
wherein the first eDRX parameter comprises a first eDRX cycle and/or a Paging Time Window (PTW), and the first eDRX cycle is greater than a predefined cycle.

2. The method of claim 1, wherein the first eDRX parameter is configured by a second network device for the terminal device, and the method further comprises:
receiving, by the terminal device, a Radio Resource Control (RRC) release message from the second network device, the RRC release message carrying the first eDRX parameter.

3. The method of claim 1, further comprising: monitoring, by the terminal device, the paging without using the first eDRX parameter, comprising one of:
monitoring, by the terminal device, the paging without using a Radio Access Network (RAN) eDRX cycle;
monitoring, by the terminal device, the paging without using an eDRX cycle;
monitoring, by the terminal device, the paging using a second eDRX parameter; or
monitoring, by the terminal device, the paging without using the first eDRX parameter and the second eDRX parameter,
wherein the second eDRX parameter comprises a second eDRX cycle, and the second eDRX cycle is less than or equal to the predefined cycle.

4. The method of claim 3, wherein
monitoring, by the terminal device, the paging without using the RAN eDRX cycle, or monitoring, by the terminal device, the paging without using the first eDRX parameter and the second eDRX parameter comprises: monitoring, by the terminal device, the paging using a Core Network (CN) eDRX cycle and/or a Discontinuous Reception (DRX) cycle; and/or
monitoring, by the terminal device, the paging without using the eDRX cycle comprises: monitoring, by the terminal device, the paging using the DRX cycle.

5. The method of claim 1, wherein determining, by the terminal device, whether to monitor the paging using the first eDRX parameter based on the first information comprises:
when the terminal device is configured with the first eDRX parameter, and the first information indicates that the terminal device is allowed to monitor the paging using a Radio Access Network (RAN) eDRX cycle greater than the predefined cycle, monitoring, by the terminal device, the paging using the first eDRX parameter, or
when the terminal device is configured with the first eDRX parameter, and the first information indicates that the terminal device is not allowed to monitor the paging using a Radio Access Network (RAN) eDRX cycle greater than the predefined cycle, monitoring, by the terminal device, the paging without using the first eDRX parameter.

6. The method of claim 5, further comprising:
receiving, by the terminal device, second information from the first network device;
wherein when the terminal device is configured with the first eDRX parameter, and the first information indicates that the terminal device is not allowed to monitor the paging using the RAN eDRX cycle greater than the predefined cycle, monitoring, by the terminal device, the paging without using the first eDRX parameter comprises:
when the terminal device is configured with the first eDRX parameter, the first information indicates that the terminal device is not allowed to monitor the paging using the RAN eDRX cycle greater than the predefined cycle, and when the second information indicates that the terminal device is allowed to monitor the paging using an RAN eDRX cycle less than or equal to the predefined cycle, monitoring, by the terminal device, the paging using a second eDRX parameter, wherein the second eDRX parameter comprises a second eDRX cycle, and the second eDRX cycle is less than or equal to the predefined cycle, or
when the terminal device is configured with the first eDRX parameter, the first information indicates that the terminal device is not allowed to monitor the paging using the RAN eDRX cycle greater than the predefined cycle, and when the second information indicates that the terminal device is not allowed to monitor the paging using an RAN eDRX cycle less than or equal to the predefined cycle, monitoring, by the terminal device, the paging without using an RAN eDRX cycle, or monitoring, by the terminal device, the paging without using the first eDRX parameter and a second eDRX parameter, wherein the second eDRX parameter comprises a second eDRX cycle, and the second eDRX cycle is less than or equal to the predefined cycle.

7. The method of claim 3, wherein the second eDRX parameter is sent to the terminal device from a second network device, and the method further comprises:
receiving, by the terminal device, a Radio Resource Control (RRC) release message from the second network device, the RRC release message carrying the second eDRX parameter.

8. The method of claim 1, wherein the terminal device is in an inactive state.

9. A communication method, comprising:
sending, by a first network device, first information to a terminal device; and
determining, by the first network device, whether to send a paging using a first Extended Discontinuous Reception (eDRX) parameter based on the first information,
wherein the first eDRX parameter comprises a first eDRX cycle and/or a Paging Time Window (PTW), and the first eDRX cycle is greater than a predefined cycle.

10. The method of claim 9, wherein the first eDRX parameter is sent to the first network device from a second network device, and the method further comprises:
receiving, by the first network device, a paging carrying the first eDRX parameter from the second network device.

11. The method of claim 10, wherein receiving, by the first network device, the paging carrying the first eDRX parameter from the second network device comprises:
when the first information sent to the second network device from the first network device indicates that the terminal device is allowed to monitor the paging using a Radio Access Network (RAN) eDRX cycle greater than the predefined cycle, receiving, by the first network device, the paging carrying the first eDRX parameter from the second network device.

12. The method of claim 9, further comprising: sending, by the first network device, the paging without using the first eDRX parameter, comprising:
sending, by the first network device, the paging using a Core Network (CN) eDRX cycle and/or a Discontinuous Reception (DRX) cycle.

13. The method of claim 9, wherein
the first information indicates that the terminal device is allowed to monitor the paging using a Radio Access Network (RAN) eDRX cycle greater than the predefined cycle; or
the first information indicates that the terminal device is not allowed to monitor the paging using the RAN eDRX cycle greater than the predefined cycle.

14. The method of claim 9, wherein determining, by the first network device, whether to send the paging using the first eDRX parameter based on the first information comprises:
when a second network device configures the first eDRX parameter for the first network device, and the first information indicates that the terminal device is allowed to monitor the paging using a Radio Access Network (RAN) eDRX cycle greater than the predefined cycle, sending, by the first network device, the paging using the first eDRX parameter, or
when a second network device configures the first eDRX parameter for the first network device, and the first information indicates that the terminal device is not allowed to monitor the paging using a Radio Access Network (RAN) eDRX cycle greater than the predefined cycle, sending, by the first network device, the paging without using the first eDRX parameter.

15. The method of claim 14, further comprising:
sending, by the first network device, second information to the terminal device;
wherein when the second network device configures the first eDRX parameter for the first network device, and the first information indicates that the terminal device is not allowed to monitor the paging using the RAN eDRX cycle greater than the predefined cycle, sending, by the first network device, the paging without using the first eDRX parameter comprises:
when the second network device configures the first eDRX parameter for the first network device, the first information indicates that the terminal device is not allowed to monitor the paging using the RAN eDRX cycle greater than the predefined cycle, and when the second information indicates that: the terminal device is allowed to monitor the paging using an RAN eDRX or the terminal device is allowed to monitor the paging using an RAN eDRX cycle less than or equal to the predefined cycle, sending, by the first network device, the paging using a second eDRX parameter, wherein the second eDRX parameter comprises a second eDRX cycle, and the second eDRX cycle is less than or equal to the predefined cycle, or
when the second network device configures the first eDRX parameter for the first network device, the first information indicates that the terminal device is not allowed to monitor the paging using the RAN eDRX cycle greater than the predefined cycle, and when the second information indicates that: the terminal device is not allowed to monitor the paging using an RAN eDRX or the terminal device is not allowed to monitor the paging using an RAN eDRX cycle less than or equal to the predefined cycle, sending, by the first network device, the paging without using the RAN eDRX cycle, or sending, by the first network device, the paging without using the first eDRX parameter and a second eDRX parameter, wherein the second eDRX parameter comprises a second eDRX cycle, and the second eDRX cycle is less than or equal to the predefined cycle.

16. The method of claim 15, wherein the second eDRX parameter is sent to the first network device from a second network device, and the method further comprises:
receiving, by the first network device from the second network device, a paging carrying the first eDRX parameter and the second eDRX parameter, or a paging carrying the second eDRX parameter.

17. A communication method, comprising:
sending, by a second network device, a paging carrying a first Extended Discontinuous Reception (eDRX) parameter to a first network device,
wherein the first eDRX parameter comprises a first eDRX cycle and/or a Paging Time Window (PTW), and the first eDRX cycle is greater than a predefined cycle.

18. The method of claim 17, wherein sending, by the second network device, the paging carrying the first eDRX parameter to the first network device comprises:
when first information received by the second network device from the first network device indicates that a terminal device is allowed to monitor a paging using a Radio Access Network (RAN) eDRX cycle greater than the predefined cycle, or indicates that a terminal device configured with the first eDRX cycle greater than the predefined cycle is allowed to monitor the paging using an eDRX, sending, by the second network device, the paging carrying the first eDRX parameter to the first network device.

19. The method of claim 17, further comprising:
sending, by the second network device, a paging carrying a second eDRX parameter or a paging carrying the first eDRX parameter and the second eDRX parameter, to the first network device, wherein the second eDRX parameter comprises a second eDRX cycle, and the second eDRX cycle is less than or equal to the predefined cycle,
wherein sending, by the second network device, the paging carrying the second eDRX parameter or the paging carrying the first eDRX parameter and the second eDRX parameter, to the first network device comprises:
when first information received by the second network device from the first network device indicates that a terminal device is not allowed to monitor a paging using a Radio Access Network (RAN) eDRX cycle greater than the predefined cycle or indicates that a terminal device configured with the first eDRX cycle greater than the predefined cycle is not allowed to monitor the paging using an eDRX, sending, by the second network device, the paging carrying the second eDRX parameter or the paging carrying the first eDRX parameter and the second eDRX parameter, to the first network device.

20. The method of claim 17, further comprising:
configuring, by the second network device, the first eDRX parameter and/or a second eDRX parameter for a terminal device, the first eDRX parameter and/or the second eDRX parameter being used for the terminal device to monitor a paging, wherein the second eDRX parameter comprises a second eDRX cycle, and the second eDRX cycle is less than or equal to the predefined cycle,
wherein configuring, by the second network device, the first eDRX parameter and/or the second eDRX parameter for the terminal device comprises:
sending, by the second network device, a Radio Resource Control (RRC) release message to the terminal device, the RRC release message carrying the first eDRX parameter and/or the second eDRX parameter.
